(19) United States
(12) Patent Application Publication
(10) Pub. No.: US 2016/0217509 A1
(43) Pub. Date: Jul. 28, 2016

(54) APPARATUS AND METHOD FOR MANAGEMENT OF ELECTRONIC RECEIPTS AND EVALUATION OF THE FAIR MARKET VALUE OF GOODS BASED ON FREE-FORM DESCRIPTIONS OF GOODS AND SHOPPERS BUYING HABITS

(71) Applicants: York Eggleston, IV, Baltimore, MD (US); Gennadiy Kolesnik, Richmond Hill (CA)

(72) Inventors: York Eggleston, IV, Baltimore, MD (US); Gennadiy Kolesnik, Richmond Hill (CA)

(21) Appl. No.: 14/603,942

(22) Filed: Jan. 23, 2015

(51) Int. Cl. G06Q 30/02; G06Q 20/20

(52) U.S. Cl. CPC G06Q 30/0283; G06Q 20/209

(57) ABSTRACT

A system, apparatus and method for the management of electronic receipts and evaluation of the fair market value of goods and services is disclosed. Fair market values of goods and services may be generated from free-form descriptions of goods and services, as well as consumers' purchasing habits. The system, apparatus and method may comprise a computerized system for managing electronic receipts, and determining the fair market value of products and services. The system may include an Electronic Receipt Management Subsystem for managing Electronic Receipts associated with transactions for purchases of one or more of goods and services. The system may also include a Fair Market Value Estimation Subsystem which operably interacts with said Electronic Receipt Management Subsystem. Fair Market Value Subsystem may calculate a fair market value of a product or service from a free-form description of a product or service being analyzed based upon Electronic Receipt data and information as well as other data and information collected from other sources. The system may analyze Search Queries, normalize the terms of such search queries and utilize such normalized search queries for the analysis of the Fair Market Value of a product or service and or other analytics related to commercial transactions.

### FIELD OF THE INVENTION

This invention relates generally to the acquisition, storage, management, processing and analysis of documents and other records as well as the information contained therein. This invention also relates generally to the determination, processing and evaluation of the fair market value of goods, services, real estate, securities, and/or any other product or service on which a fair market value may be placed. More specifically, and in certain embodiments of the invention, the invention relates to apparatus and methods for managing electronic receipts of transactions and/or evaluating the fair market value of goods and/or services based upon information gathered from such receipts and/or from any other available source of information. The invention further relates to systems and methods for evaluating and/or establishing a personalized fair market value of goods and services based on analysis of free-form descriptions of goods and/or services and/or shoppers' buying habits.

### BACKGROUND OF THE INVENTION

Fair market value (“FMV”) of goods and services may be estimated by applying statistical methods to pricing information of items being advertised for sale, as well as data from the actual transactions. This information may be obtained through various channels, such as shopping Application Programming Interfaces (“API”) provided by various merchants, web scraping, and data from electronic receipts.

Pricing data that represents the final price actually paid for the merchandise, obtained from sources such as electronic receipts, or merchants' private APIs, is far more valuable for estimation of FMV since it more accurately reflects how much buyers are willing to pay for a given item. Also, the analysis of pricing data from various sources shows that often there is a significant difference between the non-negotiable price advertised at online and brick-and-mortar retailers, and the final price paid for the same item at auctions such as eBay, Bonanza, etc. with auction prices being lower, which reflects variations in shopping preferences of buyers looking for a good deal vs. buyers looking to get the merchandise sooner, retailer's reputation, return/exchange policies, etc. This observation suggests that a personalized estimate of the FMV based on buyer's individual preferences and habits is often desired and may be calculated based on the previously observed shopping habits and/or stated preferences in the buyer's individual profile.

This also underlines the fact that the purpose of obtaining, and hence, the meaning of FMV is different for buyers and sellers. For buyers, a meaningful estimate of a fair market value answers the question of how much this particular buyer should expect to pay for an item with his/her shopping preferences, and whether a particular offer represents a fair deal. For sellers, a meaningful estimate of FMV he may answer questions of how much the seller may expect to receive for the merchandise, what the best selling format is (fixed price, auction, etc.), and/or how the price compares to the price of the same or similar items offered by other retailers, so that the seller can make an informed decision on how to price an item in the most optimal way with respect to the selling strategy (e.g. quickest sale vs. highest proceeds).

Some of the more significant problems an implementer of such a system faces may include:

(1) Availability of pricing data, especially the most valuable post-transaction data showing the price at which an item was actually sold; and/or

(2) Equating multiple various free-form descriptions that actually represent the same item.

The first problem may be solved by looking at receipt data, since every receipt contains a description of an item purchased and the price at which it was purchased, purchase date, retailer and other information, making it one of the most reliable sources of information for FMV estimation. A service that combines receipts from multiple merchants may also provide a variety of pricing data from different vendors.

The second problem may present a more significant challenge. There are no universal rules that all merchants follow when they write item descriptions. Descriptions like “IPHONE 5 32 GB”, “Apple iPhone 5” and “Brand-new, unopened iPhone 5 with 32 GB of memory” represent the same item (iPhone 5), while “Screen protector for iPhone 5” does not, despite the fact that all of them contain the “iPhone 5” string. While in the above case may be resolved by looking at the price distribution (multi-hundred dollar item vs. $5-10 item), that is not always the case. Consider, for instance, descriptions such as “Canon 7D body” vs “Canon 7D with 18-55 mm lens”, where an item is sold on its own (e.g. SLR camera body), or bundled with another item (e.g. lens) and the price of the bundled item (e.g. lens) is relatively small compared to the price of the main item (e.g. camera body). In this case the two descriptions do not represent the same item and cannot be reliably distinguished by applying statistical methods to their price information.

Apart from estimating FMV of a given product, other valuable information may be derived from data obtained from receipts. Individuals' shopping habits may be deduced by looking at what they have bought, how much they paid for, what they bought, whether they returned or exchanged the merchandise soon after the purchase, preferred places of shopping, which items are frequently bought together, etc. This information may be used to produce personalized estimates of FMV that takes a buyer's shopping preferences into account, as well as to target specific advertisement that is likely to be of interest to the buyer.

Also, the collection and management of electronic receipts may provide convenience for the users. A centralized e-receipt management system may provide many advantages compared to e-mailed copied of paper receipts, which are gaining popularity these days.

Accordingly, there exists a need for a system and method which provides a computerized system serving one or more of the following purposes:

Centralized management of electronic receipts;

Secure shopper identification at a point of sale;

Automatic award of loyalty points;

Automatically identifying the same merchandise described by free-form text;

Analysis of shoppers' buying habits;

Estimation of Fair Market Value of goods and services;

Personalized estimation of Fair Market Value of goods and services for individual buyers;

Providing services for targeted advertising based on shoppers' buying preferences and current needs;

Alerting users about purchase-related events and deadlines (e.g. refund/exchange/warranty period expiration), sales for items they regularly buy, etc.;

Price monitoring; and/or

Advising merchants on best pricing and sale format for individual products in their product catalogs and monitoring pricing for competitiveness.

### SUMMARY OF THE INVENTION

The present invention relates to a system and method for determining, analyzing, evaluating, using, comparing, verifying, and/or validating the fair market value of goods and services. In certain embodiments the fair market value system, apparatus and method of this invention may utilize the analysis of free-form descriptions of such goods and services and/or purchaser's buying habits. The present invention also relates to a system and method for managing, storing, analyzing, using, comparing, verifying, and/or validating hard copy as well as electronic transactional receipts. The present invention further relates to a system, apparatus and method which, in one non-limiting embodiment integrates one or more of these systems, apparatus and/or methods.

In certain embodiments, the system, apparatus and method of the instant invention may comprise a user interactive or other automated system, such as a computerized system, which utilizes the input or acquisition of data from one or more sources. Such data may be input to the system of this invention through one or more computerized input/output devices such as computer terminals, servers, laptop computers, smart tablets, smart phones, or other portable or non-portable electronic devices.

The data may then be analyzed, transformed, or otherwise processed via one or more computerized processing devices, each of which may comprise both a computer processor and associated software which includes instructions for appropriate processing of such data.

The input and processed data may also be stored in accordance with the system, apparatus and method of this invention in one or more storage devices, such as computer memory devices, for archiving and later retrieval by the system of this invention for further processing and/or as output data generated by the computerized system. Output data may also be stored in one or more such storage devices for archiving and later retrieval, further processing, and/or as output data generated by the computerized system of this invention.

Data input to, processed by, or output from the system of this invention may be retrieved by users of the system and apparatus of this invention through one or more computerized input/output devices such as computer terminals, servers, laptop computers, smart tablets, smart phones, or other portable or non-portable electronic devices.

The system and method of the instant invention may also be carried out via computerized systems which may be accessed either through closed architecture computerized systems such as, for example, client and server computer networks, and/or through open architecture computerized systems such as, for example, web-based portals accessed via the Internet.

The system, apparatus and method may comprise a computerized system for managing electronic receipts, and determining the fair market value of products and services. The system may include an Electronic Receipt Management Subsystem for managing Electronic Receipts associated with transactions for purchases of one or more of goods and services. The system may also include a Fair Market Value Estimation Subsystem which operably interacts with said Electronic Receipt Management Subsystem. Fair Market Value Subsystem may calculate a fair market value of a product or service from a free-form description of a product or service being analyzed based upon Electronic Receipt data and information as well as other data and information collected from other sources. The system may analyze Search Queries, normalize the terms of such search queries, and utilize such normalized search queries for the analysis of the Fair Market Value of a product or service and or other analytics related to commercial transactions.

In one embodiment, an apparatus for determining a Fair Market Value of one or more items of products and services may comprise: (i) a FMV Front-End Data Input Device; (ii) a FMV Application Server; and (iii) a Database. The FMV Front-End Data Input Device may allow data and information associated with a product or service item may be input into the FMV apparatus. The FMV Application Server may receive the data and information input into said FMV Front-End Data Input Device, process the information and data, and generate a FMV Price Estimate of the Item. The database provides one or more locations in which the data, information, and FMV Price Estimate generated by said FMV Application Server may be stored and retrieved.

In another embodiment, an apparatus for managing Electronic Receipts associated with transactions for purchases of one or more of goods and services may comprise: (i) a Retail Front-End Interface (ii) a User Front-End Interface; (iii) an Electronic Receipt Application Server; and (iv) a Database. The Retail Front-End Interface may allow data and information associated with products and services offered by one or more Merchants, and Electronic Receipt data and information associated with said transactions to be input into the apparatus by one or more Merchants. The User Front-End Interface may allow a User to access the User's Electronic Receipt data and information associated with the User's purchases of one or more product or service Items from one or more Merchants. The Electronic Receipt Application Server, may allow Electronic Receipt data and information to be: (i) received from one or more of the Retail Front-End Interface and the User Front-End Interface; (ii) processed by said Electronic Receipt Application Server; and (iii) accessed by Users through said User Front-End Interface, and Merchants through said Retail Front-End Interface. The Database provides one or more locations in which in the Electronic Receipt data and information associated with the transactions for the purchase of one or more of goods and services may be stored and retrieved.

In another embodiment, a system for managing electronic receipts and determining a fair market value of products and services may comprise: (i) an Electronic Receipt Management Subsystem; and (ii) a Fair Market Value Estimation Subsystem. The Electronic Receipt Management Subsystem may allow for receiving, storing and managing of Electronic Receipts associated with transactions for purchases of one or more of goods and services. The Fair Market Value Estimation Subsystem may be in operable communication with said Electronic Receipt Management Subsystem, wherein the Fair Market Value Subsystem may calculate a fair market value of a product or service from a free-form description of said product or service.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention, in which like numerals refer to like parts, and wherein:

FIG. 1 is a diagram illustrating an embodiment of the system, method, architecture and dataflow of the present invention;

FIG. 2 is a diagram illustrating an embodiment of the Electronic Receipt Management service, system, method, architecture and dataflow of the present invention;

FIG. 3 is a diagram illustrating embodiments of systems, methods, architecture and dataflow which may be utilized for integrating a Point of Sale with the system, method, architecture and dataflow of the present invention;

FIG. 4 is a diagram illustrating an embodiment of the Fair Market Value Estimation service, system, method, architecture and dataflow of the present invention;

FIG. 5 is a diagram illustrating an embodiment of data collection system, method, architecture and dataflow which may be utilized in connection with the system, method, architecture and dataflow of the present invention;

FIG. 6 is a diagram illustrating an embodiment of the system, method, architecture and dataflow for the processing of new queries which may be used in connection with the system, method, architecture and dataflow of the present invention;

FIG. 7 is diagram illustrating an embodiment of the system, method, architecture and dataflow for the grooming of a listing generated by the system, method, architecture and dataflow of the present invention;

FIG. 8 is diagram illustrating an embodiment of the system, method, architecture and dataflow for the un-grooming of a listing generated by the system, method, architecture and dataflow of the present invention;

FIG. 9 is diagram illustrating an embodiment for the weighting of a sorted list by position generated by the system, method, architecture and dataflow of the present invention;

FIG. 10 is diagram illustrating an embodiment the system and method for validating pricing data generated by the system, method, architecture and dataflow of the present invention;

FIG. 11 is a diagram illustrating an embodiment of the system, method, architecture and dataflow for automatically calculating an estimate of the Fair Market Value of a product or service in accordance with the system, method, architecture and dataflow of the present invention; and

FIG. 12 is a diagram illustrating an embodiment of the system, method, architecture and dataflow for automatically charging advertisers based upon actual purchases in connection with the system, method, architecture and dataflow of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in a typical inventory tracking system. Those of ordinary skill in the pertinent art may recognize that other elements may be desirable and/or required in order to implement the present invention. However, because such elements are well known in the art, and because they do not facilitate a better understanding of the present invention, a discussion of such elements is not provided herein.

Reference will now be made in detail to several exemplary and non-limiting embodiments of the present invention, some of which are illustrated in the accompanying drawings.

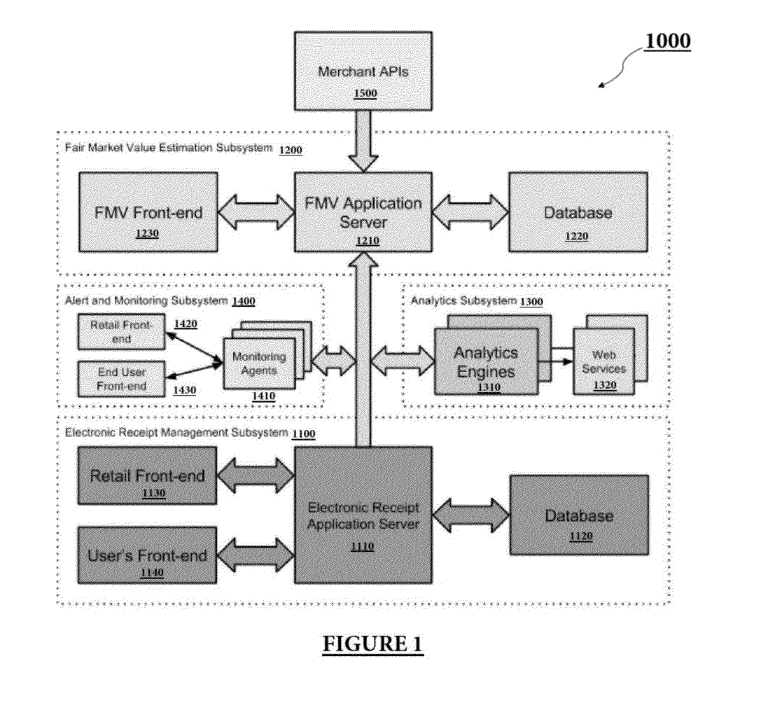

Turning now to FIG. 1, there is shown a diagram illustrating an embodiment of the system, method, architecture and dataflow 1000 of the present invention. In this embodiment, System 1000 may comprise one or more of: (i) Electronic Receipt Management System 1100, which may provide for the collection of transactional data and/or information from one or more points-of-sale, and/or maintenance of purchase receipts and other data and/or information related to such transactions; (ii) Fair Market value Estimation System 1200 which may provide for the collection, estimation, calculation, analysis, and/or dissemination of the fair market value of products and services in accordance with the instant invention; (iii) Analytics System 1300 which may provide for the collection, estimation, calculation, analysis, and/or dissemination of information related to shoppers' purchasing habits and/or patterns, product and/or service pricing trends, and/or similar information; and/or (iv) Alert and Monitoring System 1400 which may provide for users of System 1000, including but not limited to purchasers of products and/or services, and/or sellers of products and/or services to set alerts to inform such users about various events concerning products, services, and/or other information available through System 1000; and/or (v) user interfaces and/or data and/or information input and/or devices.

With further reference to FIG. 1, in one embodiment of the invention System 1000 may be configured to provide for interaction between different components of System 1000 comprising one or more of:

1. Electronic Receipt Management Service/System/Subsystem 1100;

2. Fair Market Value Estimation Service/System/Subsystem 1200;

3. Analytics Engine/Service/System/Subsystem 1300; and/or

4. Alert and Monitoring Service/System/Subsystem 1400.

In this embodiment, Electronic Receipt Management Subsystem 1100 may collect transaction data from a point of sale (e.g. at Retail Front-End Interface 1130), and maintain purchase receipts from participating merchants in a centralized, secure location or locations (e.g. at Database 1120), providing a single place for the end user to view and manage receipts from multiple merchants (e.g at Users Front-End Interface 1140). Electronic Receipt Management System 1100 may also allow merchants to simplify the process of exchanging and/or returning merchandise by eliminating the need for paper receipts to be presented by shoppers at a time a product or service is exchanged and/or purchase price refunded.

Further in this embodiment, Fair Market Value Estimation Subsystem 1200 may provide for an estimate of Fair Market Value (“FMV”) of any item (e.g. product or service) identified by a UPC/GTIN/ISBN or other code, and/or a free-form text description. Fair Market Value Estimation Subsystem 1200 may utilize data and other information from various sources, including Electronic Receipt Management Subsystem 1200, Merchants' Product/Service APIs 1500, publically available information accessible by scraping the Web, and/or other available sources.

Also in this embodiment, Analytics Subsystem 1300 may produce various information about shoppers' buying habits and patterns, price trends, etc. This information may be used for various purposes, including, but not limited to, targeted advertising, buying advice, selling advice, etc. Combined with Fair Market Value Estimation Subsystem 1200, and Electronic Receipt Management Subsystem 1100, System 1000 may also produce personalized estimates of FMV for a specific shopper, with such shopper's individual shopping preferences and patterns factored into such personalized estimates of FMV.

Further in this embodiment, Alert and Monitoring Subsystem 1400 may allow buyers and/or merchants to set alerts to be sent to inform buyers, merchants and/or other users of System 1000 about various events and/or other information, such as changes in FMV of specific merchandise and/or services, FMV crossing preset thresholds, expiration of exchange and refund periods, expiration of manufacturer's and store warranty periods, and/or other information.

In one embodiment of the invention, Electronic Receipt Management Subsystem 1100, Fair Market Value Estimation Subsystem 1200, and Alert and Monitoring Subsystem 1400 may work as both interactive and automated systems for both shoppers and merchants and therefore require a user interface. These user interfaces may be implemented as web/desktop or/and mobile applications. Functionality for shoppers and merchants may be separated, but within a single category of users (e.g. shoppers vs. merchants), and/or all three services may be integrated together into a single application.

A. Electronic Receipt Management Service and System

Certain other features of Electronic Receipt Management System 1100 may be found in various embodiments of the instant invention.

In one such embodiment, it is common that most, if not all, retail outlets, whether brick-and-mortar or online, produce a receipt for every retail transaction made, such as for a purchase, refund or exchange. These receipts are commonly printed on paper. A few more advanced merchants now have the capability to e-mail an electronic copy of the receipt to an e-mail address provided by the buyer. While this is a simple solution, e-mail may not be an optimum medium for managing electronic receipts for, in some instances, one or more of the following reasons:

1. An e-mail address needs to be provided for every transaction, which is inconvenient for the user and is prone to errors;

2. E-mail does not provide a convenient user interface to manage receipts and does not provide searching and/or sorting functionality by merchant, time, category, or other classification;

3. E-mail does not provide any means for providing any analytics and/or analytic functionality;

4. E-receipts in the e-mail mailbox are mixed with other messages that do not contain receipts; and/or

5. E-mail does not allow for integration with other services, such as payment processing, rewards programs, and/or other services.

Accordingly, a dedicated service for e-receipt management such as, for example, Electronic Receipt Management System 1100 of the present invention is a much more attractive alternative for the management of electronic receipts.

High Level Design and Flow

In one embodiment of the invention, Electronic Receipt Management System 1100 would enable both consumers and merchants to register with an Electronic Receipt Management Service (“ERM Service”) associated with Electronic Receipt Management System 1100 in order to participate in and use Electronic Receipt Management System 1100.

1. Merchant Registration

In certain embodiments of the invention, a participating merchant may open a merchant account with the ERM Service associated with Electronic Receipt Management System 1100, and provide some or all of following information as is appropriate for the particular ERM Service:

a. Business name, contact information;

b. Administrator(s) contact information, login names and passwords;

c. A list of individual sites;

d. Accepted forms of payment;

e. A list of rewards/points programs the merchant participates in; and/or

f. Other information relevant to the provision of the particular ERM Service.

Upon completion of the registration process a merchant may receive a security token comprising one or more of the following as is appropriate for the particular ERM Service:

a. A unique Merchant ID;

b. A unique Site ID (identifying individual stores belonging to the same merchant) for each site;

c. E-Receipt Service public key;

d. Access credentials for account administration; and/or

f. Other information relevant to the security token and/or provision of the particular ERM Service.

In this embodiment, Merchant's point of sale (“POS”) software may also be integrated with the ERM Service by programming terminals at one or more retail locations with the Merchant ID, Site ID, and/or other security credentials.

Additional integration with product catalogs and inventory management systems also may be required or desirable, and may depend on the hardware and software used by each individual merchant.

The Merchant Registration process may be completed online by visiting a secure web site and/or using a mobile or a desktop application or other interface. All information provided during registration may be stored securely in a database.

2. Consumer Registration

In certain embodiments of the invention, a consumer who wishes to use the e-receipt service may open a consumer account by providing some or all of following information as is appropriate for the particular ERM Service:

a. A unique User ID (typically an e-mail address) and password;

b. Name and contact information;

c. Payment (e.g. credit/debit) card numbers and/or other payment methods, descriptions payment information;

d. Rewards and loyalty points card/account numbers; and/or

e. Other information relevant to the provision of the particular ERM Service.

The Consumer Registration process may be completed online by visiting a secure web site and/or using a mobile or a desktop application or other interface.

In some embodiments of the invention, all information except password and payment card numbers may be stored securely in a database. In order to maintain the security of passwords, in some cases only a cryptographic hash (SHA-1, SHA-256 or alike) may be stored. In order to maintain the security of payment cards and other forms of payment, in some cases only a card type (Visa, MasterCard, AMEX, Interac, etc.), a cryptographic hash (SHA-1, SHA-256 or alike) of the card number and an optional description may be stored. When a user has not provided a card description, the last 3 or 4 digits of the card number may be used instead.

Upon completion of the Consumer Registration process, a unique account number may be assigned to the consumer. A plastic card with the account number encoded on it may be mailed to the consumer. The account number on the plastic card maybe be encoded using various technologies, including, but not limited to, a magnetic strip, a bar code, a QR code, an NFC/RFID chip, or other encoding methods. In certain embodiments, consumers may also download a mobile app which may emulate the payment card by displaying a bar code or a QR code that may be scanned from the mobile device's screen, or by transmitting the account number using NFC. The mobile app may also emulate reward and/or loyalty cards associated with the account in the same or similar fashion. This card is generally optional and may only be needed in connection with cash transactions.

3. System Architecture

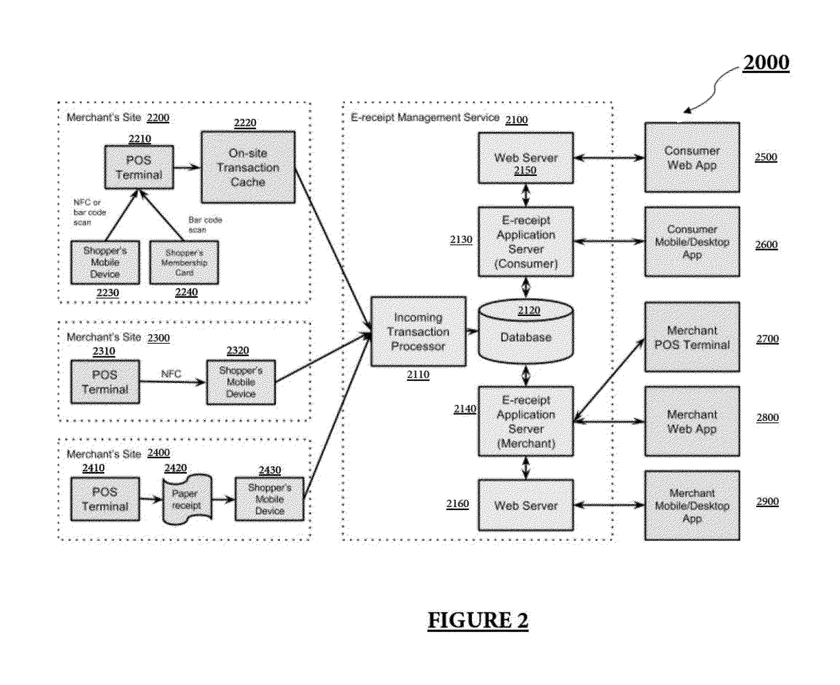

Turning now to FIG. 2, there is shown a diagram illustrating another embodiment of Electronic Receipt Management System 1100, depicted therein as Electronic Receipt Management System 2000. In this embodiment, Electronic Receipt Management System 2000 comprises: (i) E-Receipt Management Service 2100; and (ii) one or more Merchant's Sites, depicted in FIG. 2 as Merchants' Sites 2200, 2300 and 2400. It should be noted that this embodiment of the invention may incorporate one or more Merchant's Sites, or no Merchant's Sites. If no Merchant Sites are employed, other means of entering and/or accessing transaction data and other information to E-Receipt Management Service 2100 may be utilized.

Electronic Receipt Management System 2000 may also comprise one or more of: (i) Consumer Web App 2500; (ii) Consumer Mobile/Desktop App; (iii) Merchant Point of Sale (“POS”) Terminal; (iv) Merchant Web App 2800; and/or (v) Merchant Mobile/Desktop App 2900.

In one embodiment of the invention, Point of Sale (“POS”) Terminal 2200 may process a consumer purchase and payment. When a credit or debit card is used, the credit or debit card number may be sent to a payment processor. In addition, a cryptographic hash of the card number may be calculated as described above. This hash may be sent to E-receipt Management Service 2100. E-receipt Management Service 2100 may then match the hash of the payment card to those stored in Database 2120 and, when a match is found, automatically identify the consumer's e-receipt account number in System 2000. Thus, in this embodiment, no further identification of the consumer may be required at the time of sale.

In case of a cash (or equivalent) payment, the consumer may present or otherwise input into POS Terminal 2210 either a Card 2240 bearing the e-receipt service account number, or Mobile Device 2230 emulating such a card. The e-receipt account number may then be sent from POS Terminal 2210 to E-Receipt Management Service 2100 as read from the Card 2240 or Mobile Device 2230.

To accommodate for possible interruptions in the connection between Merchant's Site 2220 and E-Receipt Management Service 2100, some or all transaction data may be passed through a transparent, local cache, such as On-Site Transaction Cache 2220, located at or otherwise associated with Merchant's Site 2200. When E-Receipt Management Service 2100 is unavailable, all transaction data may be accumulated in On-Site Transaction Cache 2220, and may be sent to E-Receipt Management Service 2100 when a connection is restored. When the connection between Merchant's Site 2200 and E-Receipt Management Service 2100 is operational, On-Site Transaction Cache 2220 may act as a pass-through, transparent component.

Alternatively, POS terminal 2210 may transfer receipt information to Shopper's Mobile Device 2230 (such as, for example, a smartphone or other portable computing device), which, in turn, would submit the receipt information to E-Receipt Management Service 2100, either immediately, or later, when the internet connection is available, or at a time when transmission costs are less expensive. This approach may be preferable to smaller merchants as it requires minimal investment on the merchant's side since it does not require connecting POS Terminal 2210 equipment to the internet.

The receipt data may also be transferred to a shopper's mobile device using one or more of the following systems and/or methods:

a. A POS terminal may be equipped with a Near Field Communication (“NFC”) device, so that the mobile device may be brought into proximity with the NFC device so that the receipt data is transferred to the mobile device, similarly to making a payment with an NFC-equipped credit card. The receipt data may then be transferred to the shopper's mobile device from the POS. Please see below for additional detail. One embodiment of this system and method is depicted in FIG. 2 as Merchant's Site 2300, in which POS Terminal 2310 is equipped with an NFC device which may transfer receipt data from POS Terminal 2310 to Shopper's Mobile Device 2320. The receipt data may then be transferred from Shopper's Mobile Device 2320 to E-Receipt Management Service 2100;

b. A POS terminal may print a QR code encoding all or some of the receipt data on a paper receipt. This QR code may be scanned into the shopper's mobile device using the mobile device's built-in camera, or into a personal computer (“PC”) using a suitable connected imaging device, such as, for example, a scanner or a web camera, and decoded using a suitable QR decoding technology. One embodiment of this system and method is depicted in FIG. 2 as Merchant's Site 2400, in which POS Terminal 2410 may print or otherwise create an image of Paper Receipt 2420 bearing receipt data. The image bearing the receipt data may then be transferred to Shopper's Mobile Device 2430 via imaging and/or decoding technology. The receipt data may then be transferred from Shopper's Mobile Device 2430 to E-Receipt Management Service 2100; and/or

c. In yet another embodiment of the instant invention, a standard paper receipt may be scanned into a shopper's mobile device or PC using a camera or a scanner, converted to text using the Optical Character Recognition (OCR) software and parsed as text. This embodiment is possible as most, if not all, paper receipts have a very well-defined structure and can be easily parsed and analyzed.

In another embodiment of the instant invention, some merchants already offer a service that allows for e-mailing a copy of a receipt to an e-mail address provided by the shopper. E-Receipt Management Service 2100 may also be integrated with such systems by providing a special e-mail address where e-receipts may be received. Once received, an e-receipt may be processed in at least one or more of the following ways:

a. The receipt text may be embedded in the e-mail body. In this embodiment, the e-mail may be scanned for a two-column table where the left column contains item descriptions and/or UPC codes of a product or service, and the right column contains the sale price related to that product or service. The Merchant ID may be determined by matching the e-mail address the e-mail containing the e-receipt originated from, or the Merchant ID may be found in the e-mail itself, such as, for example, at the top of the e-mail body. The date of purchase may be determined from the time when the e-mail with the e-receipt was sent, or from other data identifying information; or

b. The receipt may be sent as an attachment in a commonly recognizable format, such as, for example, PDF, DOC, ODF, JPG or PNG. Some of these formats, such as PDF or DOC, are parseable and allow for extraction of the text contained in them. In this embodiment this text may be processed the same way as the e-mail body, as described previously. Other formats, such as JPG and PNG, may contain an image of the receipt. In such cases the image may be converted to text using OCR software and parsed as text, similarly to e-receipts scanned from paper receipts.

Turning again to FIG. 2, a message containing the transaction data may then sent from the Cloud Transaction Cache to Incoming Transaction Processor 2110. In one embodiment, Incoming Transaction Processor 2110 may comprise an application server which performs one or more of the following functions:

a. Identifying the target consumer E-receipt account by comparing the cryptographic hash of the payment card used in the transaction to the cryptographic hashes of payment cards registered with E-receipt Management Service 2100 by its users, or by directly using an account number scanned from E-Receipt Card 2240 or Mobile Device 2230 bearing E-Receipt Management Service 2100 account number, provided as part of a transaction;

b. Identifying rewards/loyalty programs the merchant participates in, and returning the account numbers of matching programs the consumer participates in to the merchant based on preferences specified by the consumer at the time of registration. The retrieved rewards/loyalty programs accounts may then be automatically credited by the merchant as if these numbers were scanned from their corresponding cards at the Point Of Sale;

c. Saving the E-receipt data in Database 2120, associating such data with the target consumer E-receipt account, and/or the merchant's account; and/or

d. Providing E-receipt data to various Analytics Engines and/or Servers, such as, for example, E-Receipt Application Server (Consumer) 2130 and/or E-Receipt Application Server (Merchant) 2140.

Consumers may also access E-receipt Management Service 2100 using an Internet-based client application, such as a Web Application run in a Web Browser (e.g. Consumer Web App 2500), or a mobile and/or a desktop application (e.g Consumer Mobile/Desktop App 2600). These client applications may communicate with E-receipt Management Service 2100 through an Application Programming Interface (“API”) provided by E-receipt Application Server (Consumer) 2130, either directly, as it would be in the case of a mobile or a desktop application (e.g. Consumer Mobile/Desktop App 2600), or through a Web server (e.g. Web Server 2150), as it would be in the case of a Web browser (e.g. Consumer Web App 2500). The protocol between the client and the server preferably should be secure and utilize encryption and may be based on standard Web technologies, including, but not limited to, REST, SOAP, HTTP/HTTPS, SSL, etc.

Given the foregoing system, method and architecture, as exemplified in FIG. 2, Consumers may perform the following functions using the client application which, in certain embodiments may be accessed by consumers through Consumer Web App 2500 and/or Consumer Mobile/Desktop App 2600:

a. View and organize a Consumer's receipts (which may also, for example, be sorted by date, merchant, location, total price, and/or frequency of purchase, etc.);

b. Search Consumer's receipts for individual items by keywords, UPC/GTIN/ISBN code, and/or price, etc.;

c. View return and/or exchange terms and deadlines for individual items purchased, if such information is provided by the merchant;

d. Receive automatic reminders about approaching deadlines for return and/or exchange, rebates, price match guarantees and warranty terms;

e. Delete or otherwise manage e-receipts;

f. View analytics data provided by Analytics Engines, which may include, but not be limited to, the following:
(i) comparison of the price paid to the Fair Market Value;
(ii) personalized FMV estimate based on shopper's buying preferences and habits;
(iii) current best deals for regularly purchased items and related items;
(iv) current price trends and historical price data for individual items;
(v) total savings on the entire consumer's basket (e.g. items purchased over a period of time) compared to the FMV of the basket; and/or
(vi) view the overall “Smart Shopper” indicator showing how well the consumer's shopping habits fair against market average;

g. Receive automatic notifications about identical items becoming available at a lower prices when price match guarantee is still in effect;

h. View terms and conditions of a sale; and/or

i. Research FMV of items not yet purchased.

Similar to consumers, merchants may also access E-receipt Management Service 2100 using a Web, mobile or a desktop client application (e.g. Merchant Web App 2800 and/or Merchant Mobile/Desktop App 2900), or at a Point Of Sale (e.g. Merchant POS Terminal 2700). The structure and/or architecture of Merchant's E-receipt Application Server 2140 is similar to the one of the Consumer 2130. In certain embodiments, the functionality at the Point of Sale (e.g. Merchant POS Terminal 2700) may be different from the functionality of the Web, desktop or mobile applications (e.g. Merchant Web App 2800 and/or Merchant Mobile/Desktop App 2900).

In certain embodiments, Merchants may perform one or more of the following functions using Merchant's POS application (e.g. Merchant POS Terminal 2700):

a. Retrieve individual transaction records for transactions performed by the Merchant and by the Consumer E-receipt Service account number provided by the Consumer (e.g. scanned from Consumer's E-receipt Service card or a mobile device) to perform a return, exchange, a price match rebate, and/or other purpose;

b. Validate the method of payment used for purchase and refund by comparing the cryptographic hash of the payment card number; and/or

c. Validate the FMV of an item for the purpose of applying price match guarantee Rebates, or other purpose.

In certain embodiments, Merchants may perform one or more of the following functions using a Web, desktop or mobile applications (e.g. Merchant Web App 2800 and/or Merchant Mobile/Desktop App 2900):

a. One or more of each of the functions performed at the Merchant's POS application as described above;

b. View sales reports by item and/or by retail location/site;

c. Compare prices of individual items to their FMV;

d. Compare prices of individual items to prices at selected competitors (if available);

e. Receive notifications when sale prices differ from the FMV by more than a given margin;

f. Receive notifications when sale numbers of a certain item are above and/or below certain thresholds at certain retail locations/sites; and/or

g. Research FMV of individual items.

In addition, Merchants may also develop their own proprietary analytics engines that may be plugged into E-Receipt Management Service 2100 by means of a Web API or other suitable interface. Such engines may be run by merchants, at their own sites, with the consent of an entity running E-Receipt Management Service 2100, FMV Estimation, and/or other analytics services.

4. Integration of NFC with Point of Sale Equipment

As may be used in certain embodiments of the instant invention, Near Field Communication (“NFC”) may be used to transfer receipt data from the Point of Sale (POS) to the Shopper's mobile device for further submission to the E-receipt service. One example of such functionality is depicted in FIG. 2 at Merchant's Site 2300. In this embodiment, NFC is used to transfer receipt data from POS Terminal 2310 to Shopper's Mobile Device 2320. Depending on the design of the existing POS equipment, several design alternatives for integration of NFC are available.

a. Fully Integrated NFC

When a POS is designed from scratch, NFC may be built into the POS. This design may be similar to the design of any computer system equipped with NFC, such as a smartphone or tablet.

b. Retrofitting NFC into Existing POS Equipment

In certain embodiments, a POS may be equipped with a printer, which prints a paper receipt. Printers are often separate devices which are connected to a POS through interfaces like USB, Centronics parallel port, or others, however, such printers may also be integrated into a POS.

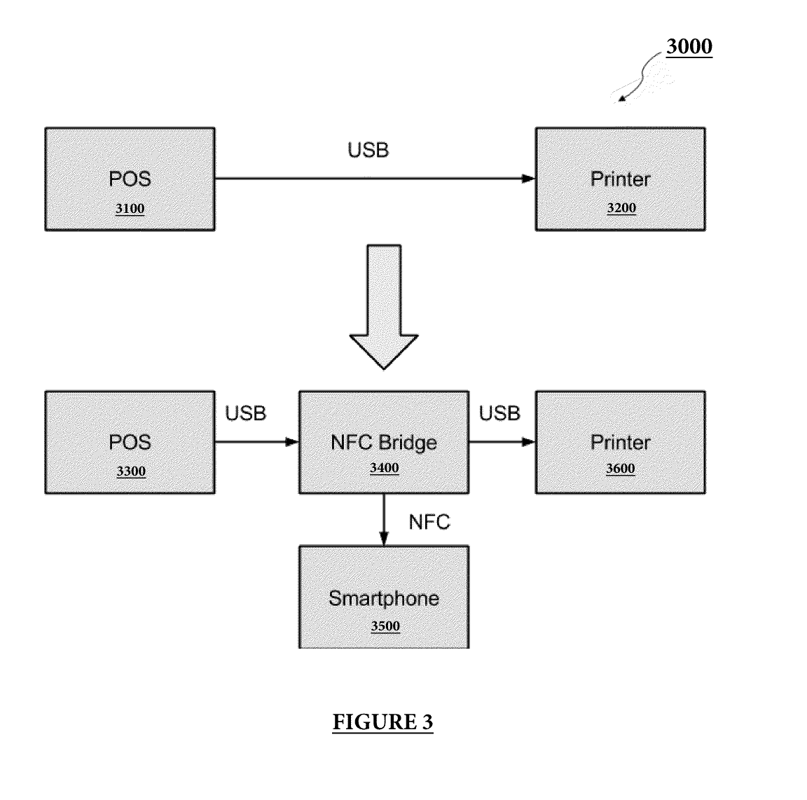

Turning now to FIG. 3, there is shown a diagram illustrating embodiments of systems, methods, architecture and dataflow 3000 which may be utilized in the integration of a POS with the system, method, architecture and dataflow of the present invention. In one embodiment, POS 3100 may be directly connected to printer 3200 via a USB or other suitable wired or wireless connection.

In another embodiment shown in FIG. 3, an external NFC device (e.g. NFC Bridge 3400) may be connected between a POS (e.g. POS 3300) and a printer (e.g. Printer 3600). For simplicity we will assume that Printer 3600 is connected to POS 3300 via USB, however, this approach is equally applicable to any other hardware interface and wired and/or wireless connections.

NFC Bridge 3400 may comprise a smart pass-through device, which looks like Printer 3600 to POS 3300. NFC Bridge 3400 may further comprise two communication interfaces allowing NFC Bridge 3400 to connect to POS 3300 and Printer 3600, an NFC interface allowing NFC Bridge 3400 to communicate with a mobile device, such as a smartphone, tablet, or other portable device (e.g. Smartphone 3500), and a microprocessor which processes the data sent by POS 3300 to Printer 3600. NFC Bridge 3400 receives data which is destined to Printer 3600 and forwards the data to Printer 3600, while analyzing the data and sending the data to the shopper's mobile device (e.g. Smartphone 3500) via NFC Bridge 3400 in a format which the mobile device understands. NFC Bridge 3400 may also add additional machine readable information to a paper receipt, such as, for example, a QR code containing receipt data, which may be scanned by mobile devices that are not equipped with NFC.

The design of NFC Bridge 3400 software may depend upon the operating environment of POS 3300 and the type of Printer 3600 used to print receipts. In certain embodiments, design approaches may be placed into one or more of the following categories:

a. Printer 3600 is a text-only device which receives data in plain text format. This may be the easiest case to implement as text data may be easily parsed into a structured format, such as XML, JSON, etc. However, such a printer may not be able to print a QR or bar code. No drivers may be necessary to modify on the POS 3300 side since NFC Bridge 3400 may simply relay messages between POS 3300 and Printer 3600 unaltered; and/or

b. Printer 3600 is a graphical device, which receives data as raster or vector image. In this embodiment NFC Bridge 3400 may present itself to POS 3300 as a different printer. Depending upon the operating environment of POS 3300, a printer driver may be required. Alternatively, NFC Bridge 3400 may present itself as a printer which understands common formats used in printing, such as Postscript, PCL, RichText, XML, etc. NFC Bridge 3400 may have to contain a driver for the actual printer connected to its output port (e.g. Printer 3600), which would translate the input data format understood by NFC Bridge 3400 to the format understood by the printer. The software in NFC Bridge 3400 may also produce an image of the receipt being printed internally and apply an Optical Character Recognition (OCR) algorithm to digitize the text on the receipt and convert such text to a structured format (e.g. XML, JSON, etc) which may be transmitted to a shopper's mobile device (e.g. Smartphone 3500) via NFC. The same information may also be encoded in a QR code, which may be added to the image being sent to the real printer (e.g. Printer 3600), which would print the receipt, along with the QR code, on paper. This QR code may later be scanned into any device to be submitted to the E-Receipt Management Service (e.g. E-Receipt Management Service 2100).

c. Multi-Party Receipts

In certain embodiments of the instant invention, multiple parties may be involved in a single transaction with a single buyer. For example, an item may be sold and the payment is collected by one merchant, but the sale is fulfilled by another. Other scenarios may include, but not be limited to, brick-and-mortar retailers performing return/exchange services for online-only merchants, manufacturers being automatically sent a copy of the sales receipt for warranty registration purposes and so on.

In such embodiments, a merchant issuing an e-receipt may specify additional Merchant IDs with which the e-receipt should be associated, similar to specifying additional e-mail addresses in the CC field of an e-mail. In this embodiment some or all merchants associated with a receipt may have read-only access to this specific receipt and may reference such a receipt when handling returns, exchanges, warranty claims, etc.

The issuing merchant may also limit access of other parties to certain fields of the e-receipt. For example, the sale price may be made inaccessible to other parties, but may be visible only to the buyer and seller. Also, in case of a multi-item e-receipt, third-party access may be restricted to certain items on the e-receipt only.

d. E-Receipt Data

In certain embodiments of the invention, it may be necessary or desirable for E-receipts to contain one, more than one, or all of the following transaction data when submitted to the E-Receipt Management Service (e.g. E-Receipt Management Service 2100) by a merchant:

a. Merchant ID and Site ID;

b. Additional Merchant IDs when multiple parties are involved in the transaction and their access permissions;

c. Consumer's E-receipt account number or a cryptographic hash of a payment card;

d. Method of payment;

e. Date and time of the transaction;

f. Type of transaction (purchase, refund, exchange, rebate, etc.);

g. Itemized list of items purchased/returned/exchanged/rebate applied to, including the following:
(i) Full item description as a free-form text;
(ii) Item category;
(iii) UPC/GTIN/ISBN code of the item;
(iv) Merchant's proprietary product ID or part number;
(v) Item condition (new/used/refurbished/not working/etc.);
(vi) Item price and any individual discounts or fees;
(vii) Currency code;
(viii) Return/exchange policy;
(ix) Return deadline;
(x) Exchange deadline;
(xi) Manufacturer's warranty expiration date;
(xii) Store warranty expiration date; and/or
(xiii) Additional Merchant IDs the item is visible to (such as, for example when the when multiple parties are involved in the transaction) and such Merchant's access permissions;

Shipping cost, carrier and tracking info, when applicable;

Taxes;

Total amount of the transaction;

Term and conditions that are typically printed on the back of a paper receipt; and/or

Any additional messages to the consumer.

B. Fair Market Value Estimation Service and System

The Fair Market Value Estimation Service of the present invention may utilize and enhance the intelligence and cognitive abilities of the users of the Fair Market Value Estimation Service in learning how to distinguish and equate free-form text descriptions of items the fair market value of which is being estimated.

High Level Design and Flow

Referring again to FIG. 1, there is shown an embodiment of the Fair Market Value (“FMV”) Estimation Service, system, method, architecture and dataflow of the present invention, depicted therein as Fair Market Value Estimation Subsystem 1200. It should be noted that FMV estimation Subsystem 1200 may operate independently of other systems and subsystems, or be integrated with other systems and subsystems as, for example, shown in FIG. 1.

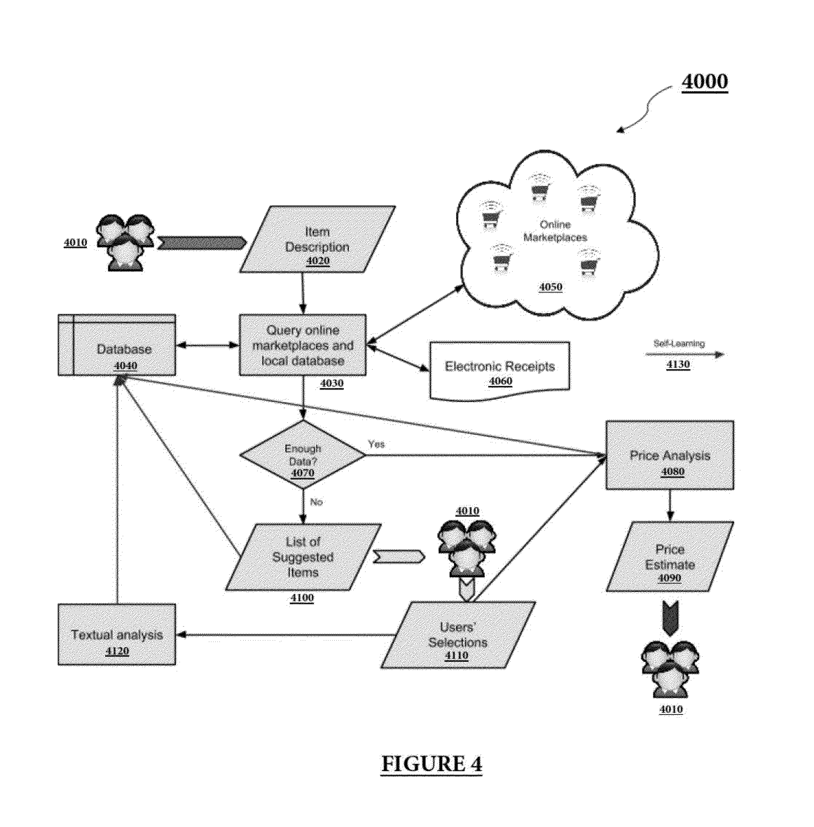

In this embodiment, FMV Estimation Subsystem 1200 comprises: (i) FMV Application Server 1210 (which in one embodiment, shown in FIG. 4, may comprise one or more of Query Processor 4030, Data Comparator 4070, FMV Price Analysis Engine 4080, List of Suggested Items Processor 4100, User Selection Device 4110, and/or Textural Analysis Engine 4120) for the generation of a Fair Market Value of the selling price a product or service item; (ii) Database 1220 (which in one embodiment, shown in FIG. 4, may comprise database 4040) for the storage and retrieval of data, search queries and/or other information associated with such product or service item; and (iii) FMV Front-End Data Input Device 1230 (which in one embodiment, shown in FIG. 4, may comprise Item Description Device 4020) into which data, search queries and/or other information associated with such product or service may be input into FMV Server. Each of Database 1220 and FMV Front-And Data Input Device 1230 may be in direct or indirect operative communication with FMV Application Server 1210.

In certain embodiments of the instant invention, FMV Estimation Subsystem 1200 may also be in operative communication with, and receive additional input data and information from Merchant APIs 1500 (which in one embodiment, shown in FIG. 4, may comprise Online Marketplaces 4050), and/or from Electronic Receipt Management Subsystem 1100 (which in one embodiment, shown in FIG. 4, may comprise Electronic Receipt Management Subsystem 4060).

As used herein, the term “operative communication” shall mean, as the context suggests, functional operation between two or more devices and/or systems including, but not limited to, interoperability by electrical connection, interoperability by mechanical connection, transmission and/or exchange of information and/or data, and/or other interoperability between devices and/or systems.

Turning now to FIG. 4, there is shown a diagram illustrating an embodiment of the Fair Market Value Estimation Service, system, method, architecture and dataflow of the present invention, depicted therein as Fair Market Value (“FMV”) Estimation System and Method 4000. In this embodiment, utilization of FMV Estimation System and Method 4000 comprises the components and/or steps of:

1. Users 4010 entering item descriptions as text (or other acceptable input format) via Item Description Device 4020;

2. Item descriptions may be searched (which, in certain embodiments, may comprise the normalization of such Item Descriptions), identified, and or retrieved via Query Processor 4030 in local Database 4040, and/or Online Marketplaces 4050, and/or Electronic Receipts 4060 (which, in certain embodiments, may comprise Electronic Receipt Management Subsystem 1110), and/or through APIs and/or scraping;

3. If enough data associated with a normalized search phrase is processed and identified by Data Comparator 4070, such data may be sent to FMV Price Analysis Engine 4080, which analyzes, processes, generates, and/or produces FMV Price Estimate 4090. Price Estimate 4090 may be presented to Users 4010 via Output Device 4090 along with, in certain embodiments, a FMV Price Estimate 4090 confidence level, and/or other analytics, and/or may be used for other purposes;

4. If there is not enough data found at Data Comparator 4070 to produce a definitive FMV Price Estimate 4090 (i.e. not enough records in the local database associated with the normalized item description), a List of Suggested Items obtained from marketplaces may be generated by List of Suggested Items Processor 4100, and presented to Users 4010 via an output device. List of Suggested Items 4100 may be organized sorted and/or organized by relevance or other desired classification, and stored in Database 4040 for later use in the processing of subsequent Item Description Queries, and/or stored in any other storage device.

5. Each User 4010 may be asked to select and input at User Selection Device 4110 one or more of the descriptions of items generated by List of Suggested Items Processor 4100 appearing on List of Suggested Items 4100 that, in such User's 4010 opinion, represent(s) the item described by the search phrase;

6. Descriptions of items selected by Users 4010 at User Selection Device 4110 may be saved in Database 4040, or other designated storage device, along with the normalized search phrase. At the same or another time a dictionary of words and combinations of words present in selected descriptions may be constructed and/or generated at Textual Analysis Engine 4120, and saved in Database 4040, or other designated storage device, in association with the normalized search phrase and in combination with the frequencies of their occurrence in selected, i.e. “preferred” and/or “correct” descriptions;

7. Items selected by a current User 4010 at User Selection Device 4110, along with the items already associated with the same normalized search phrase may be passed to a Price Analysis Engine (e.g. FMV Price Analysis Engine 4080), which may process and produce a FMV Price Estimate (e.g. Price Estimate 4090), which may be presented to User 4010 and/or saved to a database (e.g. Database 4040) in association with the normalized search query.

8. Steps 1 through 7 of this embodiment of the process of this invention may be repeated for other Users 4010 entering queries at Item Description Device 4020 that processes and/or otherwise produces the same normalized search phrase. Each time Item Descriptions 4020 that have been selected by previous Users 4010 may be eliminated from List of Suggested Items 4100. This process may be repeated until no more relevant Item Descriptions 4100 may be selected, or until FMV Price Analysis Engine 4080 processes and or produces FMV Price Estimate 4090 with reasonably high FMV Price Estimate 4090 confidence level.

9. When no more relevant suggestions may be selected from List of Suggested Items 4100, a dictionary of words and combinations of words present in the remaining Item Descriptions may be constructed, processed and/or generated at Textual Analysis Engine 4120 and saved in Database 4040 in association with the normalized search phrase and in combination with the frequencies of such normalized search phrases occurrence in “incorrect” descriptions.

10. At this point both the “correct” and the “incorrect” dictionaries associated with a given normalized search phrase may be “groomed” at Textual Analysis Engine 4120 to reduce storage space such search phrases may require in Database 4040 by eliminating statistically insignificant words and combinations of words that have low counts of appearance in either “correct” or “incorrect” dictionaries, or similar counts in both “correct” or “incorrect” dictionaries.

11. The process of this embodiment may be restarted from the beginning when FMV Price Analysis Engine 4080 rejects data based on validity criteria, or when user 4010 marks FMV Price Estimate 4090 as invalid. Rejection criteria may include multi-modal price distribution with modes of identical or similar size, insufficient data, sudden changes in the average of the otherwise stable price, etc.

Item Description Normalization

Since human users are not obligated to follow any specially defined and strictly enforced rules of describing an item, the system and method of this invention may attempt to eliminate possible variations in spelling, punctuation, grammar, case, whitespaces and non-printable characters. In one embodiment. the system and method of this invention may do so by the following procedure comprising the steps of:

1. A search query may be broken up into tokens (e.g. words) using whitespaces, punctuation marks, hyphens, colons and semicolons, quotes (single and double), brackets (all kinds), mathematical signs, characters like @, #, $, &, ̂, etc. as delimiters.

2. Leading and trailing whitespaces may be eliminated from each token.

3. Each token may be converted to either upper or lower case (the case does not matter as long as it is consistent).

4. Tokens representing articles (“A”, “THE”) and other words that are unlikely to alter the meaning of the phrase (“BY”, “OF”, “IN”, etc.) may be eliminated.

5. Tokens may be sorted in the alphabetical order (it generally does not matter whether the order is ascending or descending as long as the sorting is consistent).

6. Tokens may be concatenated together with a single space between them in the order produced by the above sorting.

7. As a performance optimization, a hash (SHA-1, MD5, CRC or others with low probability of collision) may be calculated on the normalized description and the normalized description is replaced with its hash.

The normalization process may make descriptions like “Apple iPhone 5S/32 GB”, “32 GB Apple iPhone-5S” and “IPHONE 5S by Apple 32 GB” identical, as both may be turned into “32 GB 5S APPLE IPHONE”. While this process may not be entirely precise (for example, phrases “IPHONE 5S by Apple 32 GB” and “IPHONE 5S by Apple with 32 GB” may not produce the same normalized form), the process may significantly decrease the number of permutations in search queries.

The normalized query then may be saved in the database. When a FMV estimate is calculated, such FMV estimate also may be saved in the database and/or associated with the corresponding normalized query. When a query producing the same normalized form is entered next time, the system may look up its normalized form in the database and if a price estimate associated with this normalized query is found in the database, it may be presented to the user.

Using UPC/GTIN/ISBN Codes for Item Identification

Frequently the descriptions of items may contain UPC/GTIN/ISBN digital codes. These are numerical codes that follow a set of defined rules and therefore may be easily identified. When a digital code is present in an item description, such a digital code may be extracted from the description and saved in a separate, dedicated field in the database.

Often merchants may provide the item's digital code as part of the listing in a separate field.

When a search query in entered, the search query may be first checked to determine whether the search query represents an item's digital code. When a digital code is recognized, the system may take one of the two routes, depending on its configuration:

1. Perform a search by digital code only; or

2. Perform a reverse lookup by digital code and present the user with a list of suggested descriptions found in the records of items that also reference the digital code, then follow the path of processing free-form descriptions, as described above.

Data Collection Process

When there is no FMV estimate available for a given query, the system may need to collect pricing data from external sources, such as Merchant APIs and/or Electronic Receipt Collection Systems. This process may partially rely on the search capabilities of Merchant APIs, which may vary in quality, as well as the search capabilities of the Electronic Receipt Collection System. Regardless of the quality of the search engines in these systems, such systems would typically perform a search for the words present in the search query. These inquiries often return a large number of items, some of which do represent the item being queried for, while others do not.

Since the search engines behind Merchants' APIs may rely on a certain format of the query, the original, non-normalized query may be forwarded to such Merchants' APIs. Whether a normalized or a non-normalized query is sent to the Merchant's API and/or Electronic Receipt Collection System may be made configurable per data source.

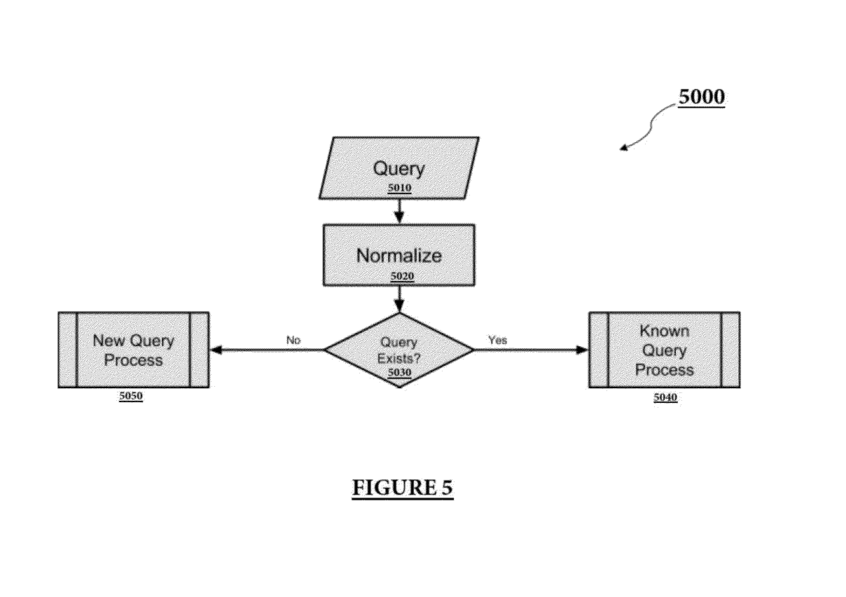

Turning now to FIG. 5, there is shown one embodiment of the normalization and determination of whether the query is known or unknown to the system of this invention. FIG. 5 depicts Search Query Subsystem 5000 where Search Query 5010 is normalized at Normalization Processor 5020 to produce Normalized Search Query.

In this embodiment, Search Query 5010 received from a Merchant's API may return a number of listings, some of which do represent the item being searched for and some do not. At this point there are two possible scenarios which may be determined at Query Analyzer 5030:

1. The Normalized Search Query is a new query that has never been entered into the system of the invention previously, which then would be transmitted to New Query Processor 5050; or

2. The Normalized Search Query has been entered into the system previously, which then would be transmitted to Known Query Processor 5040.

In both cases the system of the invention needs to identify which listings represent the item for which FMV is being evaluated and which do not. In some cases where the Normalized Search Query is processed and is a Known Query at 5040, such an identification may be processed automatically. However, in other cases the system of the invention may require intervention from a user of the system of the invention in order to narrow down the set of listings which may be used as a accurate and reliable FMV estimation. This result may be achieved by presenting a list of possible unique item descriptions to the user and asking the user to select several listings that represent the item for which FMV is being estimated from the list. See, for example, FMV Estimation System and Method 4000 depicted in FIG. 4, where Users 4010 receive List of Suggested Items 4100 generated by FMV Estimation System 4000, and then make Selections 4110, which then may be utilized by Price Analysis Engine 4080, Textual Analysis Engine 4120, and/or stored in Database 4040.

Multiple users entering queries that result in the same normalized query may be presented with the same list, from which previously selected descriptions are or have been eliminated. The system of the invention learns from the users' selections using the process described herein and below. This “Self-Learning” functionality of the system of this invention is exemplified in one embodiment depicted in FIG. 4, where Self-Learning Data 4130 may be transmitted between: (i) Price Analysis Engine 4080 and Database 4040; (ii) List of Suggested Items Generator 4100 and Database 4040; and Textual Analysis Engine 4120 and Database 4040.

In one embodiment of the invention, in order to reduce the number of requests sent to the merchants' systems, the retrieved listings may be temporarily cached in the local database along with the normalized query. Thus, subsequent queries resulting in the same normalized query may retrieve the listings from the local cache.

In yet another embodiment, for user's convenience and efficiency, whenever the system of the invention presents the user with the list of item descriptions, the system may attempt to sort the list in such a way that those descriptions that appear to be more relevant to the search query appear closer to the top of the list. This functionality may be achieved using a combination of several approaches described below.

Processing of New Queries

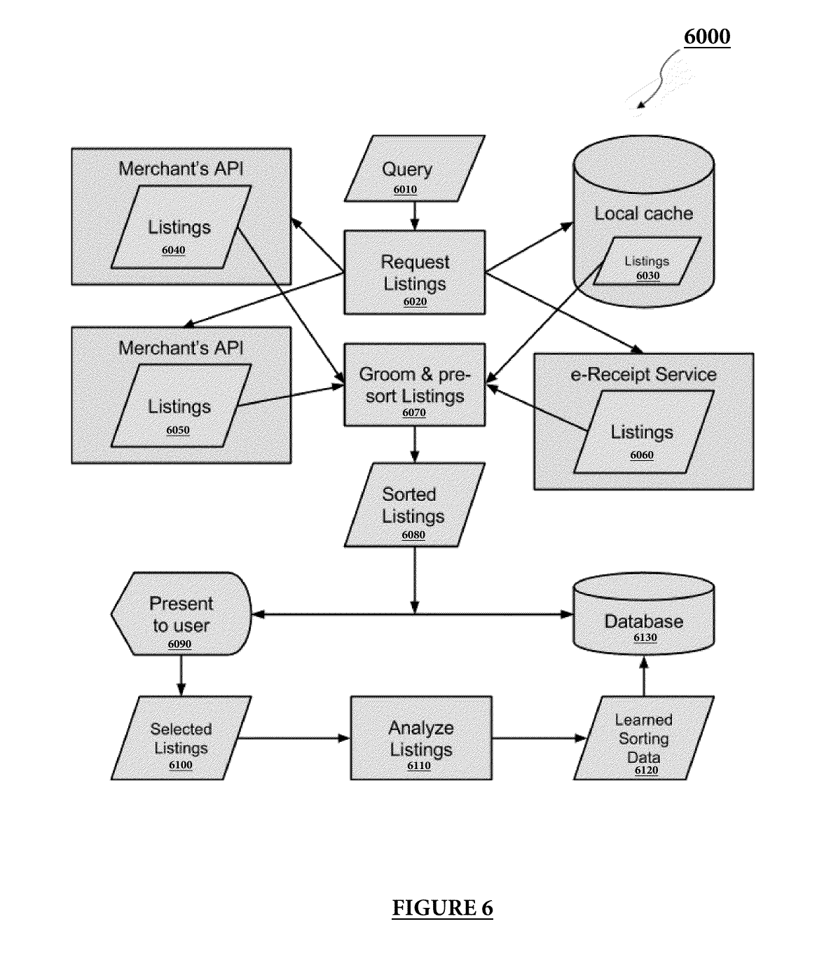

Turning now to FIG. 6, one embodiment of the system and process flow of new queries, which have never been entered into the system of the invention, is shown.

The system and process of this embodiment, New Query Processor 6000, comprises the following:

1. The user enters a new query at 6010;

2. Processor 6000 requests listings through Listing Request Processor 6020 from the local cache 6030 and/or various external data sources (e.g. Merchants' APIs 6040 and 6050, E-Receipt Management System 6060, Web scrapers, etc.). Newly acquired listings may be cached in Local Database 1630;

3. Listings received from one, more than one, or all sources may be combined in a single list at Groom and Presort Processor 6070;

4. The list generated at Processor 6070 may be “groomed” at Processor 6070 by eliminating all but one listing with equivalent descriptions, after which a pre-sorting algorithm is applied at Processor 6070;

5. The user who submitted New Query 6010 may be presented at 6090 with a sorted list of descriptions generated at Listings Sorter 6080, and asked to select a sampling of relevant items from the list (in one embodiment, for example, between 5 and 10 items may be selected, although any number of items may be designated for selection), which are selected at 6100; and/or

6. Selected Listings 6100 may be used to produce an expanded, ‘un-groomed’ set of listings, which is used for analysis at Listings Analyzer 6110, resulting in a FMV estimate presented to the user (if possible), and the initial description sorting data, which is used by the system to learn at Listings Analyzer 6110 how to recognize item descriptions relevant to a given search query in order to generate Learned Sorting Data 6120. Learn Sorting Data 6120 may be saved in the Database 6130 for future use.

List Grooming and Un-Grooming

Since it is known that descriptions received from merchants, e-receipts and other sources represent items for sale, it may be possible to make certain assumptions about them, such as:

1. Punctuation marks may be ignored;

2. Articles, such as ‘a’ and ‘the’ may be ignored;

3. Words, phrases and acronyms representing item condition, such as ‘new’, ‘used’, ‘good condition’, ‘NIB’ (‘new in box’), etc, and words and phrases that are known not to represent an item, such as ‘price’, ‘relisted’, ‘reduced’, ‘discount’, etc. may be ignored during comparisons, unless these words are present in the query itself. For example, phrases ‘iPhone 5’ and ‘Just listed: Brand-new, unused iPhone 5, listing #23456’ are considered equivalent when searching for ‘iPhone 5’; and/or

4. Numbers may be ignored during comparisons, unless present in the search phrase, or preceded by words/phrases indicating that the description represents a set of multiple items, such as ‘set of’ or ‘quantity’.

The process of ‘grooming’ takes a search query and the corresponding list of item descriptions as input and produces a shorter list of descriptions that are considered unique with the above assumptions in mind as output. When several description are considered equivalent under the above rules, only the shortest description is kept in the output set.

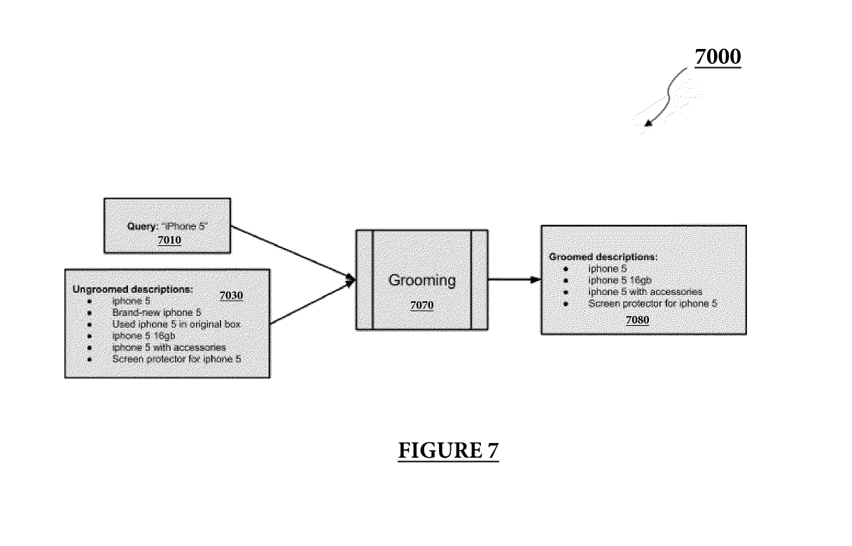

Turning now to FIG. 7, there is shown one embodiment of the system and method of Grooming 7000 which may be utilized with the instant invention comprising:

Inputting Query 7010 and Ungroomed Descriptions 7030 into Grooming Processor 7070; and

Processing Query 7010 and Ungroomed Descriptions 7030 by Grooming Processor 7070 to produce Groomed Descriptions 7080.

The process of ‘un-grooming’ takes the search query, a subset of ‘groomed’ descriptions selected by the user as representing the item being searched for, and the original list of items before ‘grooming’ as input and produces an extended set of items that match, using the above criteria, the descriptions selected by the user.

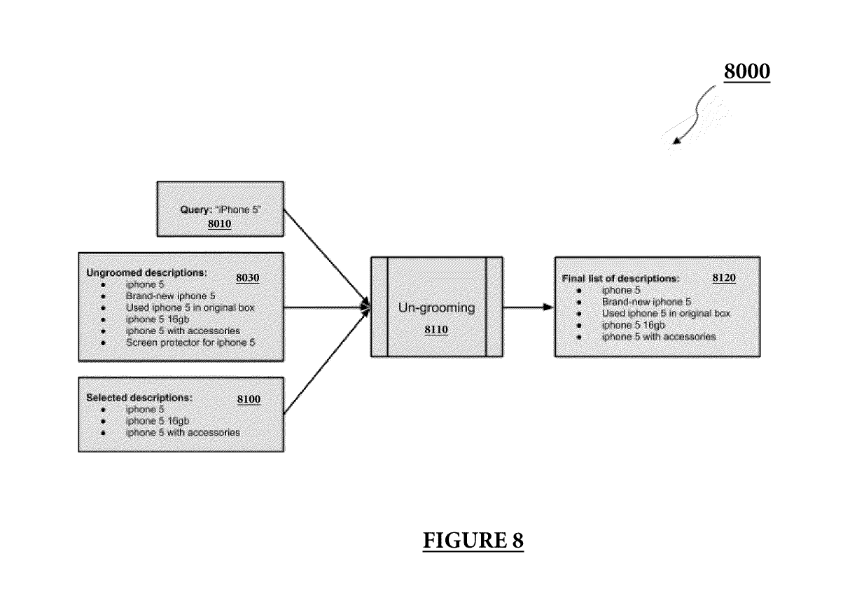

Turning now to FIG. 8, there is shown one embodiment of the system and method of Ungrooming 8000 which may be utilized with the instant invention comprising:

Inputting Query 8010, Ungroomed Descriptions 8030, and Selected Descriptions 8100 into Ungrooming Processor 8110; and

Processing Query 8010, Ungroomed Descriptions 8030, and Selected Descriptions 8100 by Ungrooming Processor 8110 to produce Final Description List 8120.

Pre-Sorting

Pre-sorting may be employed in certain embodiments of the invention as a preliminary step to sort the list of descriptions presented to the user based on two criteria:

1. Total weight of the words present in the query within the item description; and

2. Proximity of the words present in the query to the beginning of the item description.

In one embodiment, this mechanism may be implemented by calculating a weight of each groomed description using the following algorithm and sorting the listing by the resulting weight in descending order (tokens represent individual words in descriptions and search queries):

```
function calculatePositionalWeight (phraseTokens, searchPhraseTokens)
{
  var weight = 0;
  var wordsFound = 0;
  for (var i = 0; i < phraseTokens.length; i++)
  {
    for (var j = 0; j < searchPhraseTokens.length; j++)
    {
      if (searchPhraseTokens [j] == phraseTokens [i])
      {
        ++wordsFound;
        weight += (phraseTokens.length − i);
      }
    }
  }
  return weight / (phraseTokens.length − wordsFound + 1);
}
```

Processing of Already Existing Queries

Once a query has been entered into the system of this invention at least once, and users have identified at least a few relevant descriptions, such Existing Queries may be processed by the system differently from queries unknown to the system (so-called “New Queries”).

In one embodiment of the instant invention, the approach to processing Existing Queries may rely on two observations:

1. Descriptions representing the same item are likely to contain the same words; and

2. Descriptions representing different items are likely to contain other words that are not present in descriptions that do represent the item.

These observations may be illustrated using the following example and reference to FIGS. 4 and 6:

When searching for ‘Pentax K-5’ in one embodiment utilizing the system and processes of this invention, the following descriptions were received from Merchants (i.e. real eBay listings were captured):

The first group of descriptions does represent the search query ‘Pentax K-5’:

9614 shot Excellent++ Pentax K-5 (Body Only) 16.3 MP Digital SLR Camera Black s7

PENTAX K-5 16.3 MP Digital Camera Body w/Box [Excellent++] from Japan #260318

Pentax K-5 16.3 MP Digital SLR with 3-Inch LCD (Black Body Only)

PENTAX K-5 16.3 MP Digital Camera Body Only Exc+++ w/box

Pentax K-5 16.3 MP Digital SLR Camera—Black (Body Only) from Japan 49024

Pentax K-5 Digital SLR Camera—Black (Body only) in Excellent+Condition

Pentax K Series K-5 16.3 MP Digital SLR Camera Body Only from Japan

Pentax K-5 Digital SLR camera body in Mint Condition K5

(USED CLEAN) Pentax K-5 Digital SLR 16.3 MB Camera Body Only

Pentax K-5 Digital SLR 16.3 MB Camera Body Only (17123)

The second group of descriptions represents different items even though the descriptions all contain the search query itself:

Pentax K-5 IIs Digital SLR Camera

Pentax K-5II, K-5 IIs Original User Instruction Guide—Japanese

Pentax K5 Owner manual

ASAHI PENTAX K1000-5MC CAMERA LOTS OF EXTRAS EXCELLENT CONDITION

Pentax K-5 IIs Digital SLR Camera Body #12050

Pentax K-5 II Digital SLR Camera (Body Only)!! New!!

New Pentax K-5 II s 16.3 MP Digital SLR Camera Black Body Only from Japan

Pentax 12050 K-5 IIS 16.3 MP Full HD DSLR Black

Excellent Pentax K-5 II (Body Only) 16.3 MP Digital SLR Camera Black 3000 shot

In processing and analyzing these two groups of descriptions, the system and method of this invention may determine that words like ‘SLR’, ‘Digital’, ‘Body’, ‘Camera’, ‘Black’ are present in descriptions in both groups, and therefore such words will not be permitted to influence the determination about whether the description truly represents Pentax K-5′. Words ‘ASAHI’, ‘K1000’, ‘5MC’, ‘II’ and ‘HS’ are only present in the second group of descriptions, and do not represent ‘Pentax K-5’.

The descriptions belonging to both groups are normalized, broken up into words, and a dictionary of words used in descriptions is built and saved in the database. Each word in the dictionary is associated with the search query. Each association record, binding a word to a search query, may contain two counters, referred to as ‘good’ and ‘bad’, which are initially set to 0.

The user then may be presented with the combined ‘groomed’ list of suggestions, which may include both groups of descriptions. The user then may be asked to put a check mark next to the descriptions that in the user's opinion represent the item for which FMV is being evaluated. The user is presented with a FMV estimate based on items that have been selected in the current and one or more previous sessions. This process may be repeated with descriptions, marked as relevant in previous iterations, eliminated from the list until no descriptions representing the item are left. After each pass or repetition of this process, words that are present in the descriptions that have been marked as correct, have the ‘good’ counter incremented on them by 1 for each occurrence of the word. The remaining list then may be re-sorted in the order of descending weight, where weight is calculated as a sum of the weight produced by the pre-sorting algorithm described above and the weight calculated using the following formula:

$$weight = {\sum }_{i = 0}^{n} \frac{word [ i ] . GoodCount - word [ i ] . BadCount}{word [ i ] . GoodCount + word [ i ] . BadCount}$$

Once the user indicates that there are no more relevant descriptions left in the list, the remaining descriptions are treated as incorrect and all words present in them have the ‘bad’ counter incremented by 1 for each occurrence of the word. This is necessary because until this moment the system may not be able to tell whether the remaining description simply have not been selected yet, or whether they represent items different from the one represented by the search query.

When a search query is entered for the first time and before users have indicated that no more relevant descriptions are left in the list of suggestions, the above formula has no effect since the ‘bad’ count is zero. Therefore, the suggestions are still sorted by weight produced by the previously described pre-sorting algorithm. However, once the ‘incorrect’ descriptions have been identified, the above formula starts taking effect, giving a boost to the weight of descriptions that contain the words that are frequently encountered in ‘correct’ descriptions and reducing the weight of those that contain the words that are frequently encountered in the ‘wrong’ descriptions representing items that are different from the one being evaluated. Every time a list of suggestions is presented to the user and the user feedback on that list is received by the system, the values of the ‘good’ and ‘bad’ counters are saved in the database.

To reduce the size of the database storing the dictionary, it is possible to discard records with the close values of ‘good’ and ‘bad’ counters. The criterion for discarding the dictionary records can be described using the following formula:

$$\frac{abs ( GoodCount - BadCount )}{GoodCount + BadCount} \leq threshold$$

where the value of threshold is determined empirically, based on the storage capabilities available.

Since the list of suggestions is constantly sorted by weight in the descending order, the weight may be represented by a monotonously declining function with the horizontal axis representing the position in the sorted list of suggestions and the vertical axis representing the weight. At the moment when the user indicates that no more relevant descriptions are left in the list of suggestions, the weight of the item at the top of the list represents the cut-off point in this function. The FMV estimate is then calculated using the listings with the weight above the cut-off point. The FMV estimate is then saved in the database along with the date when the FMV estimate was calculated and associated with the normalized search query. Further requests resulting in the same normalized query may then return the saved FMV estimate without presenting the list of suggestions to and without requiring feedback from the user.

The FMV estimate then may be saved for a pre-defined empirically derived amount of time, usually ranging between several days and several weeks, although any time range may be designated. Once the FMV estimate has expired, the whole process may be repeated again. In subsequent iterations, however, the sorting may take advantage of the dictionary with populated ‘good’ and ‘bad’ counters from the previous estimates.

Each time the user indicates that no more relevant descriptions are left in the list of suggestions, the cut-off weight may be averaged with its previous values and saved in the database in association with the normalized search query. This information may be used by the system to attempt to automatically find the cut-off point, beyond which the descriptions are considered to be representing items that are different from the one for which FMV is being estimated. This process is further described below and herein.

While this process is not guaranteed to be absolutely precise or succeed every time, the accuracy of the results generated by the system and process of this invention improves with time, as the system learns how to recognize descriptions of the items matching repeating queries. Therefore, a mechanism to recognize failures and reject invalid data is preferred. When data is rejected, the process of learning from a user is repeated, but the system provides the user with automated assistance by processing and analyzing the breadth of data already processed, accumulated and stored within the system. Since the data validation and rejection mechanism is also based on statistical methods, it is also possible to have a ‘false positive’ identification of item descriptions as correct. Also since the system's accumulated learning may rely on at least partial user input, which is inherently prone to both bona fide and malicious incorrect input, the system and method of this invention provides for a mechanism allowing manual invalidation of the FMV estimate, and restart the process of learning from the beginning. In certain embodiments of the invention, invalidation of the FMV estimate may not erase the dictionary, or reset the ‘good’ and ‘bad’ counters so as to avoid losing the wealth of data process, analyze, and accumulated over a period of time. Assuming that the number of correct identifications should significantly exceed the number of the incorrect ones, the process, while temporarily suffering from the loss of precision, will eventually correct itself.

Automatic Estimate of the Cut-Off Weight Point

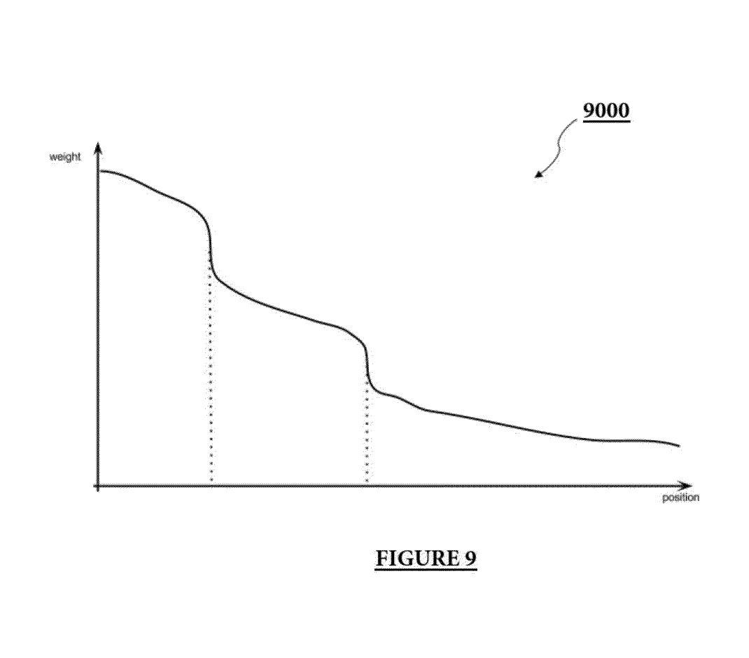

Turning now to FIG. 9, and as previously stated, the weight of entries in the sorted list of suggestions may be represented by a monotonously declining function with the horizontal axis representing the position in the sorted list of suggestions, and the vertical axis representing the weight.

As FIG. 9 illustrates, when a sufficient amount of dictionary data with ‘good’ and ‘bad’ counters set is available, the function will tend to exhibit sharp drops throughout the range of positions in the list.

These sharp drops tend to occur between groups of relatively similar descriptions that contain the same words. Using the example of listings for the ‘Pentax K-5’ query previously discussed above, it is possible to see that one of such drops would occur close to the border between the two groups of descriptions, since the ‘II’ and ‘IIS’ strings would bear a significant ‘bad’ count in the context of this search query. Therefore, points of such sharp drops may be good candidates for the cut-off points, separating the ‘correct’ and the ‘incorrect’ descriptions.

Once enough dictionary data has been accumulated, these sharp drops tend to be found in proximity to the average cut-off point for a given normalized search query. Since new descriptions of the same item are being accumulated as the system is used, the exact position and the depth of these drops may change, so the position of the largest drop, closest to the average cut-off point may be selected as the best candidate for the cut-off point of the current set of listings.

The largest drop may be found as a minimum in the second derivative of the weight function. Calculation of a derivative may be carried out by any known process.

Validation of Price Data

The methods of selection of relevant listings described herein may be based either on user input, which may be inherently error-prone, or on statistical methods, which generally involves a certain amount of approximation. It is therefore preferable to validate such data before using such data for estimation of FMV. The system and method of this invention may be adapted to provide for the validation of such data.

Price distribution of any item across a large number of merchants tends to be close to normal. However, such normalized price distribution is not always the case when the sample size is relatively small, or when the sample contains a large number of erroneous entries. Therefore, when the sample size may be considered sufficient for statistical analysis, statistical parameters may be used as data validation criteria.

Generally, two trends have been observed with erroneous data:

1. A sample contains a large number of various unrelated items sold at various prices. A good example of queries resulting in such samples are very general queries, such as “phone”, “computer”, “tire” and so on, that describe a category rather than an item. Since there are great many models of phones covering the entire price range of phones, the distribution of the price may or may not be normal (and is more likely to be linear), and standard deviation will be very large, approaching, or even exceeding mean. This type of data may be rejected as invalid; and

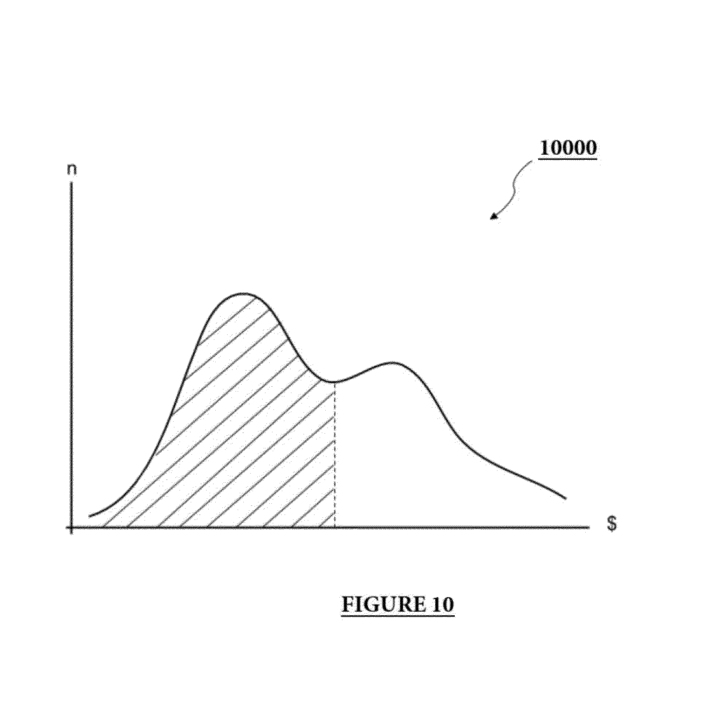

2. A large sample contains a small number of different items. This type of sample often occurs when searching for items that have several generations (for example, “iPad” includes several generations of iPad and each generation is sold at a different price), or when the sample contains the item by itself, as well as the same item bundled with other items (for example, a DSLR camera body and the same DSLR camera bundled with one or more lenses). Samples like these tend to have multi-modal distributions. As shown in FIG. 10, depending on the ratio between the modes, the sample can usually be salvaged when there is one dominant mode, where the dominance factor is calculated as a surface (integral) under each peak in the distribution, with only the largest peak being used to estimate FMV.

When a dominant peak can be found, the histogram is truncated at the lowest points of the valleys adjacent to the dominant peak. Only those samples with prices within the range of the remainder of the histogram are used for FMV estimation.

When recent historical FMV estimate is available for the same item, the dominant peak is selected based on its proximity to the average of two or three most recent estimates.

When a dominant peak cannot be identified, the entire sample may be rejected. Experimental data suggests that a peak should be about 25% larger than others to be considered dominant with samples of less than 60 items to achieve reasonable reliability. This 25% threshold may be reduced for larger samples or when recent estimates are available and consistent with the estimate obtained using the peak deemed to be considered dominant.

Confidence Level of an FMV Estimate

Depending on the final size of the sample used to calculate the FMV, the ratio of mean to standard deviation, a confidence level is assigned to the estimate. Confidence level is not a statistical parameter, but rather a measure of how well statistical methods can be applied to a given set of listings. Accordingly, the system and method of this invention may be adapted to generate a confidence level associated with an in FMV Estimate produced by the instant invention.

In one embodiment of the invention, there exists five confidence levels: Low (0), Somewhat Low (1), Moderate (2), High (3) and Very High (4). Confidence Level calculated using the following formula:

$$Conf = \frac{sample size}{5} \times \frac{mean}{σ \times 10}$$

where the denominator coefficients 5 and 10 are experimental values and may be adjusted depending on the desired precision of an estimate.

Automatic Calculation of an FMV Estimate

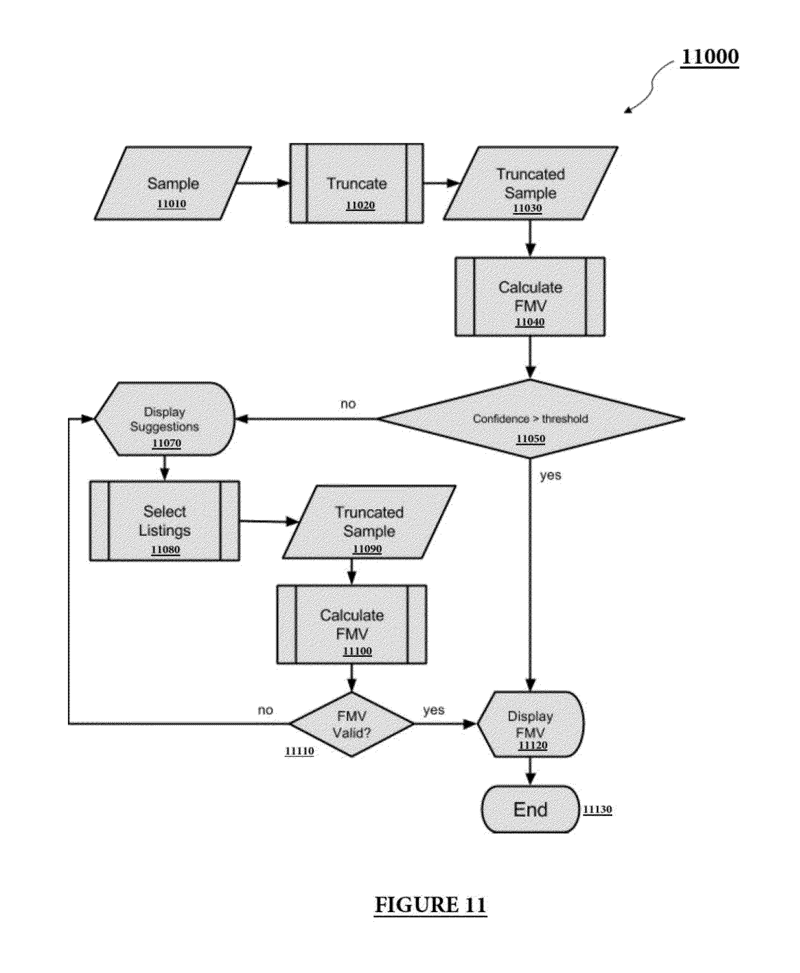

Turning now to FIG. 11, there is shown an embodiment of the system and method of this invention for the automatic calculation of an FMV estimate. A sample 11010 obtained by automatically truncating at 11020 the list of suggestions at the point of the largest drop of the weight function in proximity to the average cut-off point, which meets the above criteria, may be considered a candidate for an automatic estimate in accordance with the system and method of the instant invention. Truncated Sample 11030 is used to automatically calculate an FMV estimate at 11040

FMV estimate 11040 may be calculated using automatically Truncated Sample 11030 which comprises a set of listings. FMV estimate confidence level may be determined at 11040 using the processes described above. A threshold of confidence level may be set (it has been found that Moderate or above works reasonably well) to determine whether the FMV estimate generated by the system requires adjustment, or may be presented to the user as final without adjustment and without asking for any additional input. Such a determination is made at 11050.

If the confidence level is within the threshold parameters at 11050, the FMV estimate is displayed at 11120, and the process is concluded at 11130.

If the confidence level falls below or outside the set threshold parameters at 11050, the automatic FMV estimate is discarded and a list of suggested descriptions is displayed to the user at 11070 from which the user may to input into the system a selection of a number of relevant descriptions at 11080, as previously described.

Truncated Sample 11090 is generated from Selected Listings 11080, and a new FMV estimate is calculated at 11100. The system then analyzes the validity of the newly generated FMV estimate at 11110. If the FMV estimate is validated at 11110, FMV estimate 11110 is displayed to the user at 11120, and the process is concluded at 11130. If the FMV estimate is invalidated at 11110, newly generated FMV estimate 11100 is discarded and a list of suggested descriptions is displayed to the user at 11070 from which the user may to input into the system a selection of a number of relevant descriptions at 11080, and the process may be repeated until a valid newly generated FMV estimate 11110 is produced.

Calculation of the Fair Market Value Estimate

In certain embodiments of the instant invention, the FMV estimate may be calculated by way of a non-limiting example as follows. First, a mean of the truncated sample is calculated when the distribution of the price is normal or close to normal. When the distribution is multi-modal and a dominant peak can be identified, the histogram may be truncated at the lowest points immediately adjacent to the dominant peak. A mean is calculated using only those listings with prices that fall under the dominant peak.

The sample then may be further truncated using the three-sigma rule. The outliers outside one or two (depending on the desired precision) standard deviations from the mean may be eliminated from the sample. This truncation may be be applied selectively depending on the confidence level and/or sample size.

Fair Market Value then may be estimated as mean of the remaining sample. The reasonable price range is determined as mean+/−standard deviation. Fair Market Value then may be estimated separately for new, refurbished, used and not working items.

Special Treatment of Auction and e-Receipt Prices

As it has been stated herein, auction prices and prices obtained from electronic receipts are a preferred source for FMV estimation data as such prices and associated data represent the actual selling price of an item, as opposed to the asking price, at which an item may or may not sell. Therefore, in certain embodiments of this invention, the actual selling prices are given a higher weight by including them twice into the sample on which the FMV estimate is calculated.

By way of non-limiting example, many auction marketplaces, such as eBay, report the current bid for active auctions in the price field. The current bid is often lower than the final sale price and therefore generally is not used for the FMV estimates, however in some embodiments of this invention exception may be made. The system of this invention may record active auctions in the database and retrieve the final price at which an item was actually sold, after the auction ends, and then may recalculate the FMV estimate with the updated data. In certain cases when the newly obtained auction data invalidates the FMV estimate, the process may be repeated from the beginning as if no current pricing data is available.

C. Analytics Engines

The data collected through the use of E-receipt Management Service and the Fair Market Value Estimation Service of the present invention may provide analytics valuable to both consumers and merchants which may be processed and utilized in various embodiments of the current invention. Such analytics may be generated by the system and method of the present invention in the form of Analytics Engines which may provide for the collection, storage, processing, analysis, and delivery of such analytics and other information.

The Analytics Engines of the present invention may comprise processing devices, data storage and retrieval devices, analytical devices, data and analytics input/output devices, and other hardware and software which may be configured to achieve the functionality and interoperability of the Analytics Engines described herein. One embodiment of an Analytics Engine which is integrated into an embodiment of the system and method of the of the present invention is shown in FIG. 1 as Analytics Subsystem 1300. Analytics Subsystem 1300 comprises one or more Analytics Engines 1310. Analytics Subsystem 1300 may also comprise one or more Web Services 1320. Web the Services 1320 may act as an interface with Analytics Engines 1310 and the Internet, which enables Analytics Engines 1310 to access additional functionality, as well as data and other information which may be used in connection with the analytics being processed by analytics Engines 1310.

Consumer Analytics Engines

Personalized Fair Price Estimate Analytics Engine

Consumers often have different preferences and values when choosing a merchant to buy from. For some, price can be the main factor, for others factors such as return and exchange policies, shipping speed, shopping experience, etc. may also influence Consumers' buying decisions. These factors and their individual weight may vary for the same consumer depending upon the price range, or a category of items to be purchased. For example, consumers may be more price-conscious when buying more expensive items than when buying items that cost less, or insist on buying brand-name drugs while being content with generic brands when buying clothing or electronics. Thus, in some instances, an FMV estimate calculated based solely on the market averages, while still being a useful guideline, may be of a lesser value to individual consumers.

Having access to databases comprising data from e-receipts, as well as possibly other sources however, allows the Analytics Engines of the present invention, some of which are described below, to process and analyze individual preferences of a specific consumer and adjust the FMV estimate accordingly to produce a Personalized Fair Price (“PFP”) estimate. One or more of the Consumer Analytics Engines described below may be integrated into the system and method of the present invention.

Range Adjusted Fair Price Analytics Engine

The entire price range of items a consumer buys may be broken up into exponentially increasing ranges or bins. Items purchased by the consumer may be placed into one of the bins according to its FMV based on the market average. The actual price paid by the consumer (obtained from e-receipts and/or other sources) may be compared to the market-based FMV and the ratio of price paid, and the FMV may be averaged across all items falling under the same bin. This average ratio then may be used as a coefficient by which the market average-based FMV is multiplied to produce a range-adjusted personalized fair price (“RPFP”) estimate:

$$RPFP = FMV \times {\sum }_{i = 0}^{N} \frac{Price ( i )}{FMV ( i )}$$

Such a coefficient may be calculated for each price range containing a statistically significant number of items purchased.

Consumer-Driven Fair Price Estimate Analytics Engine

Some items are purchased by a consumer on a regular basis. This statement is true for food, personal hygiene and grooming items, household items such as, for example, laundry detergent or furnace filters, as well as other products and services. A Consumer's buying habits may be analyzed by looking at the price paid for these items over a period of time.

A Range-adjusted PFP for such items may be presented to the consumer on the regular basis, and the consumer is alerted if the price paid is higher than the suggested RPFP estimate. A price-conscious consumer may likely adjust the consumer's shopping behavior, and may start looking for a better deal on these items, which, in turn, may be reflected in the actual price paid. On the other hand, consumers who care less about the price and more about convenience are unlikely to change their behavior over time, and the ratio of price paid to the range-adjusted PFP estimate for these items may remain approximately constant. Thus, the ratio of the actual price paid to RPFP may be used as a reliable indicator of the individual consumer's shopping preferences with regards to a specific item.

When the ratio of the price paid to RPFP is not reducing to approaching 1 over a period of several buying cycles for the item, the actual average price paid may be considered a PFP estimate for the specific item for the specific consumer when the current FMV estimate for this item is lower than the actual price paid. When the FMV increases above the last price paid, the FMV estimate may be used as PFP instead.

Location-Adjusted Fair Price Estimate Analytics Engine

E-receipts may provide a wealth of information about a consumer's online vs. brick-and-mortar store shopping preference. The ratio of the number of online purchases to the number of purchases at brick-and-mortar stores may be calculated for each bin of the range-adjusted PFP. When this ratio is significantly above zero, the FMV may be calculated separately using data from online retailers only and from the sources local to the consumer only. A weighted average between the two estimates may be calculated using the following formula:

$$LPFP = \frac{FMVretail \times Nretail + FMVonline \times Nonline}{Nonline + Nretail}$$

Price History and Price Trend Analytics Engine

The FMV Estimation system may maintain a history of FMV for each item. The system may alert both or either merchants and/or consumers when the FMV or a PFP estimate of watched items goes up or down, and/or exceeds a certain threshold. This may be especially convenient for monitoring the price of regularly purchased items, so that such items may be purchased when the PFP is at the lowest, or when the PFP trends upwards.

Related Item Advisory Analytics Engine

Often items are bought together with other items. For example, consumers who buy a DSLR camera body often buy a lens for it, or people who buy toothpaste also buy toothbrushes. E-receipts may be analyzed for items that are frequently bought by the same people. Consumers who have recently purchased an item that is often bought with another item, may receive suggestions with the information and FMV estimate of the items that such consumers are likely to buy.

Product Satisfaction Index Analytics Engine

It is possible to judge how satisfied other shoppers are with a specific product by evaluating the rate of single-time and multiple time returns based on the information from e-receipts. The Product Satisfaction Index may be calculated, excluding sales with a no-return policy, using the following formula:

$$PS = \frac{Nsales - Nreturns}{Nsales}$$

Higher return rates indicate lower satisfaction levels. High values (close to 1) of Product Satisfaction Index indicate high satisfaction levels, whereas low values (close to 0) indicate low satisfaction levels.

Product Satisfaction Index may be presented to shoppers who may use the Index to make their purchasing decision about a specific product.

Initial Product Quality Index

Similarly to Product Satisfaction Index, the Initial Product Quality Index may be calculated based on the ratio of product exchanges to the same product to the total number of sales. Initial Product Quality Index can be calculated, excluding sales with a no-exchange policy, using the following formula:

$$PQ = \frac{Nsales - Nexchanges}{Nsales}$$

This formula may also be adjusted to account for final returns after one or more exchanges, excluding sales with a no-return policy:

$$PQ = \frac{Nsales - Nexchanges - ( Nexchanges > 0 ? Nreturns \text{:} 0 )}{Nsales}$$

Higher exchange and return after exchange rates indicate lower quality of a product. High levels (close to 1) of Initial Product Quality Index indicate lower initial quality of a product, while lower levels (close to 0) indicate higher initial quality of a product.

Initial Product Quality Index may be presented to shoppers who may use it to make their purchasing decision about a specific product.

Advertiser Analytics and Services

Related Item Advisory Analytics Engine

Information about consumers who have recently purchased an item, but do not seem to own items that are frequently bought by the same people who have bought the same item, may be used to deliver targeted in-app advertisements. This information may be sold to advertisers and a delivery channel in the form of a Related Item Advisory Analytics Engine which may be integrated into the system and method of the present invention and accessed by, or otherwise provided to, such advertisers.

Evaluation of Advertisement Efficiency Analytics Engines

Advertisement Efficiency may be evaluated as a ratio of shoppers who bought an item after seeing an ad to those who were presented an online in-app ad. The ad may be associated with a product ID, such as a UPC/GTIN/ISBN code or a text description, which may appear on a shopper's e-receipt.

Per-Purchase Advertising Payments Analytics Engine

Data from e-receipts allows advertisers to be charged based on the actual purchase numbers rather than per click. Payment would be remitted when a shopper is shown an ad and purchases the item being advertised. The ad may be associated with a product ID, such as a UPC/GTIN/ISBN code or a text description, which may appear on a shopper's e-receipt from a specific merchant.

This approach may also ensure that advertisers do not overcharge merchants by artificially inflating the number of clicks on the ad, or the number of times an ad is presented to potential buyers.

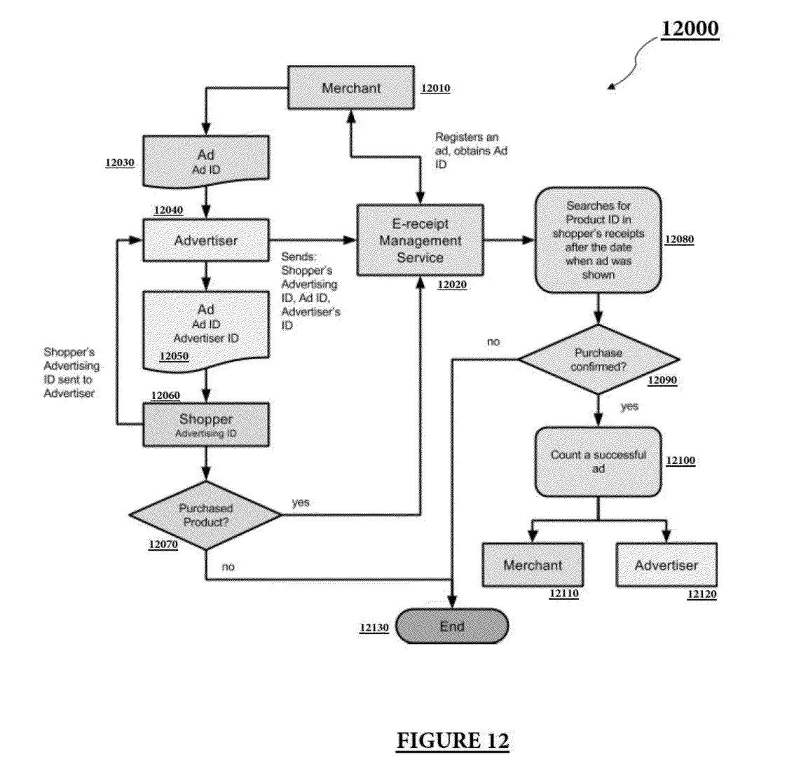

FIG. 12 depicts one embodiment of a Per-Purchase Advertising Payments Analytics Engine designated therein as 12000. The system and process of this embodiment of the invention is depicted in FIG. 12. In this embodiment, each of the parties involved in the process (i.e. Merchant 12010, Advertiser 12040, and Buyer/Shopper 12060) may be registered with the E-Receipt Management Service System 12020.

1. Merchant 12010 who wants to advertise a product registers Ad 12030 with the E-receipt Management Service 12020, and obtains a unique Ad ID 12030, which is assigned to the Ad 12030. Ad ID may be generated in a variety of ways, including, but not limited to, a Globally Unique ID (GUID), a sequential number, a hash of the Merchant ID and Product ID, etc. The exact description of the Product, as the description will appear on e-receipts issued by the Merchant, may also be registered along with the Ad ID.

2. Ad 12030, along with its unique Ad ID, may be submitted to a number of Advertisers 12040 provide Advertising Medium 12050, such as, for example, space on a Web page, or an ad-sponsored mobile, desktop or embedded application. Ad 12030 may be presented to potential buyers via Advertising Medium 12050. The meaning of “presented” may, in this instance, be defined by an agreement between Merchant 12010 and Advertiser 12040. For example, Ad 12030 may be shown, through Advertising Medium 12050, to potential Buyer 12060, or Buyer 12060 may click on Ad 12030, or on Ad 12030 may be delivered to Buyer 12060's mailbox, etc.

3. Each Shopper 12060 may be assigned a unique Advertising ID when Shopper 12060 registers with the E-receipt Management Service 12020. This Advertising ID may be any unique sequence, such as, for example, a cryptographic hash of Shopper 12060's account number or login ID, a GUID, or a sequential number. The purpose of this Advertising ID is to uniquely identify Shopper 12060 without revealing Shopper 12060's true identity or security credentials in the system to Advertisers 12040.

4. When Ad 12030 is presented to Shopper 12060, Shopper 12060's Advertising ID may be sent back to Advertiser 12040, who then may send Shopper 12060's Advertising ID to E-Receipt Management Service 12020 along with Advertiser 12040's own Advertiser ID, the Ad ID and the timestamp of when Ad 12030 was presented to Shopper 12060. Alternatively, the Advertiser ID and the Ad ID may be sent along with Ad 12030 to Shopper 12060's device on which Ad 12030 is being presented. Shopper 12060's device may then report the Advertiser ID, the Ad ID, and Shopper 12060's ID to E-Receipt Management System 12020. This alternative approach may be preferable due to the fact that it does not allow Advertiser 12040 to tamper with submissions to artificially inflate the number of times Ad 12030 was presented to Shopper 12060, however, it might be more difficult to implement due to cross-domain security policies that exist in many Web browsers. Nevertheless, both approaches may be employed at the same time depending on Shopper 12060's device.

5. E-receipt Management Service 12020 periodically checks Incoming Receipts 12080 for the presence of the product associated with the Ad ID, sold by Merchant 12010 that registered Ad 12030. When the product associated with Ad 12030 is present in one (or more) of Shopper 12060's receipts based upon a purchase at 12070 which is reported to E-Receipt Management Service 12020, and the purchase date is later than the date when Ad 12030 about this product was shown to Shopper 12060 at 12090, Ad 12030 may be considered successful at 12100 and, depending on the agreement between Merchant 12010 and Advertiser 12040, may be credited to Advertiser 12040 that presented Ad 12030 first, or to all Advertisers 12040 that presented Ad 12030 to the same Shopper 12060. Merchant 12010 then may be charged only for those Ads 12030 that were presented to Shopper 12060 and resulted in a purchase of the Product. If a purchase is not confirmed at 12090, no successful count of Ad 12030 is recorded.

Retailer Analytics

Retailers may also benefit from various analytical estimates that may be obtained using the E-receipt Management and the FMV Estimation services of the present invention in connection with appropriately configured Analytics Engines.

Price List Grooming and Monitoring Analytics Engine

Retailers with large product catalogs containing thousands of items may require a significant effort to competitively price each item and adjust the price according to constantly changing market conditions. Utilizing the FMV Estimation Service of the present invention for price list monitoring, while not 100% accurate, in association with a Price List Monitoring Service Analytics Engine may significantly reduce the costs of price monitoring.

The Price List Monitoring Service Analytics Engine may analyze each item in the merchant's product catalog and attempt to obtain an FMV estimate from the FMV Estimation Service of the present invention. Although the FMV estimate may sometimes require user intervention when item descriptions are not recognized and grouped automatically, due to the self-learning nature of the FMV Estimation Service, the probability of user intervention diminishes as the number of users of the service increases. Therefore, an automatic FMV Estimate may eventually become available for a majority, if not all, of items in the merchant's product catalog and items, for which an automatic FMV Estimate could not be obtained, can be clearly identified.

The following operations and functionality may be automated in various embodiments of the Price List Grooming and_Monitoring Analytics Engine instant invention:

Merchants may use an available FMV estimate to initially populate the Merchant's price lists with FMV data; and/or

Merchants may set certain criteria of Merchant's choice to alert Merchant when the difference between Merchant's price and the FMV exceeds a certain threshold. An alert may be sent to the Merchant, and/or prices may be adjusted automatically according to set rules.

Market Demand Monitoring Analytics Engine

Similarly to the FMV Estimate, the information provided by the E-Receipt Service may provide a good indication of the market demand for a specific item. The number of purchases of the same item across multiple merchants reflects the consumer demand for this item. When the number of sales for an item over a period of time changes significantly, exceeding a threshold set by a merchant, the merchant may be automatically alerted by the Market Demand Monitoring Analytics Engine, so that the appropriate action (price adjustment, additional advertising campaigns, etc.) may be taken.

Product Satisfaction and Initial Product Quality Indexes Analytics Engine

The same Product Satisfaction and Initial Product Quality indexes presented to consumers may also be used by merchants and product manufacturers to obtain market feedback on the satisfaction and quality of products they sell or manufacture via the Product Satisfaction and Initial Product Quality Indexes Analytics Engine.

Merchant Loyalty Index Analytics Engine

Merchants may receive analytics on how loyal their customers are the Merchant Loyalty Index Analytics Engine. To achieve this functionality, a merchant may identify merchant's competitors also subscribed to the E-receipt Management System. The service may find consumer accounts containing e-receipts from the merchant receiving the analytics. The e-receipts in these consumer accounts may be searched for records from competing merchants within a period of time specified by the merchant.

The Merchant Loyalty Index may be calculated as a ratio of the number of shoppers whose e-receipts do not contain records from competing merchants to the total number of shoppers who shopped at the merchant receiving the analytics using the following formula:

$$MLI = \frac{Nexclusive}{Ntotal}$$

Brand Loyalty Index Analytics Engine

Similar to the Merchant Loyalty Index Analytics Engine, for many items a brand loyalty index may be calculated via a Brand Loyalty Index Analytics Engine. E-receipt data of a single consumer may be analyzed to determine whether the particular consumer tends to buy products of the same brand in the same category. For example, some consumers always buy the same laundry detergent, while others tend to buy a different brand every time for various reasons, either because they are looking for a lower price, or they like to try out new products. A brand loyalty index may be determined for each type of product for each shopper. Depending upon the result, advertisements may be targeted differently for each shopper.

Targeted Survey Analytics Engine

Merchants and product manufacturers may conduct in-app surveys about products consumers have bought and about their shopping experiences based on data from e-receipts, such as product, purchase date and location via the Targeted Survey Analytics Engine. Survey questions may be configured on a per-product or per-shopping location basis, and may be displayed in the E-Receipt Management app or Web site.

Returning Customer Index Analytics Engine

Merchants may take advantage of the e-receipt data to calculate the percentage of returning customers among all shoppers without having to ask for personal information such as, for example, phone numbers, name or address and regardless of the method of payment used via the Returning Customers Index Analytics Engine. The e-receipt account number may be used as Shopper ID for this purpose.

Common Carrier Analytics Engine

Inclusion of shipping cost, carrier and tracking information in the e-receipt data allows for additional analytics that both merchants and buyers may take advantage of through the Common Carrier Analytics Engine:

a. Evaluation of FMV of shipping, per item. The same algorithms used for estimation of FMV of a particular item may be equally applied to shipping costs. This functionality allows for the estimation of the cost of shipping across different merchants and different delivery services.

b. Unbiased evaluation of delivery service reliability. The E-receipt Management Service may conduct an in-app survey of shoppers by asking such shopper's whether they have received an item when the carrier claims that the item has been delivered (carrier's data may be obtained through various APIs published by the carrier), thus allowing to establish a percentage of delivery failures per carrier. Also the distribution of delivery time may be analyzed using statistical methods (mean and standard deviation of delivery time). A consistency index may be calculated, for example, as a ratio of a mean of delivery time to its standard deviation. For simplicity, the consistency index may also be mapped to a set of levels, such as Low, Moderate, High, or similar designations.

D. Alerts and Monitoring System

Electronic receipts provide opportunities to alert both merchants and shoppers about numerous events. These alerts and reminders may be delivered to users in a variety of ways, including, but not limited to, in-app alerts, e-mail, social media postings, chat messages, SMS, etc. The aspects of delivering of these alerts may use any one of known delivery systems and devices.

One embodiment of the Alert and Monitoring Subsystem of the present invention is depicted in FIG. 1 as Alert and Monitoring Subsystem 1400. Alert and Monitoring Subsystem 1400 may comprise one or more Monitoring Agents 1410 which may interface with Retail Front End 1420 and/or End User Front-End 1430.

Various embodiments of the Alert and Monitoring Subsystem of the present invention may comprise alerts which may include one or more of the following features:

1. FMV changes. Both merchants and shoppers may select products to be monitored and set conditions for alerts, such as, for instance, the FMV of the product, or the product's sales volume moving outside a certain range. In this embodiment of the Alerts and Monitoring System may periodically re-evaluate the FMV of selected products and send an alert when alert criteria are met.

2. Exchange/return period expiration reminders to shoppers. Merchants may specify their exchange and/or return policies during the merchant registration process, or at other times. Shoppers may specify their preferences for return and/or exchange reminders globally, or per merchant, or per item. When an e-receipt is submitted to the E-receipt Management Service, a trigger is set to send an alert to the shopper, reminding the shopper that the exchange and/or return period is about to expire, according to the shopper's preferences, unless a return receipt has already been submitted for the same product from the same merchant.

3. Warranty period expiration reminders to shoppers. Shoppers may set alerts on certain items appearing on the shopper's e-receipts, reminding the shopper about the expiration of warranty periods. Multiple alerts may be set on the same item to accommodate in-store warranties, manufacturer's warranties, extended warranties, and/or other parameters.

4. Best deal alerts. Shoppers may be automatically notified when items the shopper purchases regularly are being sold at a price lower than what the shopper has been paying lately. The algorithm of identifying different descriptions of the same item described in the Fair Market Value Estimation Service section may be used to identify the same item sold by different merchants even when the item description is not exactly the same across merchants.

5. Competitor price monitoring for merchants. Merchants may identify other merchants they compete with in order to monitor their pricing of the same merchandise. The algorithm of identifying different descriptions of the same item described in the Fair Market Value Estimation Service section may be used to identify the same item sold by different merchants even when the item description is not exactly the same across merchants.

6. Monitoring delivery of purchased goods for both buyers and merchants. Carrier and tracking information may be included in the e-receipt, and the service may periodically query the carrier for the shipment status through an API provided by the carrier. When the shipment is approaching delivery, the buyer may be alerted by the Electronic Receipt Service through an in-app alert, e-mail, SMS or a message through a social network. This information may also be used for carrier analytics as further described herein.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

What is claimed is:

1. An apparatus for determining a Fair Market Value of one or more items of products and services comprising:
a FMV Front-End Data Input Device into which data and information associated with a product or service item may be input into said apparatus;
a FMV Application Server, wherein said FMV Application Server may receive said data and information input into said FMV Front-End Data Input Device, process said information and data, and generate a FMV Price Estimate of said Item; and
a database in which one or more of said data, information, and FMV Price Estimate generated by said FMV Application Server may be stored and retrieved.

2. The apparatus of claim 1, wherein said FMV Application Server further comprises a Query Processor and a Data Comparator, wherein said Data Comparator compares data received from said Query Processor and determines if enough data is present to generate a FMV Price Estimate of said Item.

3. The apparatus of claim 2, wherein said Query Processor may receive an Item Description Query, search for Items having descriptions associated with said Item containing one or more terms appearing in said Item Description Query, and retrieve said descriptions associated with said searched Items.

4. The apparatus of claim 2, wherein said FMV Application Server further comprises a FMV Price Analysis Engine which, if enough data is associated with said Item Description Query, said FMV Price Analysis Engine analyzes said retrieved descriptions associated with said searched Item, and generates a FMV Price Estimate for said Item associated with said Item Description Query.

5. The apparatus of claim 2, wherein said FMV Application Server further comprises a List of Suggested Items Processor, wherein if there is not enough data is associated with said Item Description Query, said List of Suggested Items Processor analyzes said retrieved descriptions associated with said searched Items, generates a List of Suggested Items, organizes said List of Suggested Items, and provides for the storage of said List of Suggested Items for use in the processing of subsequent Item Description Queries.

6. The apparatus of claim 5, wherein said FMV Application Server further comprises a Textual Analysis Engine generates a dictionary of one or more of preferred or correct words and phrases present in said List of Suggested Items for use in the processing of subsequent Item Description Queries.

7. The apparatus of claim 2, wherein said Query Processor normalizes said retrieved descriptions associated with said searched Items.

8. An apparatus for managing Electronic Receipts associated with transactions for purchases of one or more of goods and services comprising:
a Retail Front-End Interface into which data and information associated with products and services offered by one or more Merchants, and Electronic Receipt data and information associated with said transactions may be input into said apparatus by said one or more Merchants;
a User Front-End Interface from which a User of said apparatus may access said user's Electronic Receipt data and information associated with said User's purchases of one or more product or service Items from one or more Merchants;
an Electronic Receipt Application Server, wherein said Electronic Receipt data and information may be received from one or more of said Retail Front-End Interface and said User Front-End Interface, processed by said Electronic Receipt Application Server, and accessed by Users through said User Front-End Interface, and Merchants through said Retail Front-End Interface; and
a Database in which said Electronic Receipt data and information associated with said transactions for said purchase of one or more of goods and services may be stored and retrieved.

9. The apparatus of claim 8, wherein said Electronic Receipt data and information includes one or more of a description of the product or service purchased, a selling price, a date of purchase, merchant identification, purchaser identification, loyalty program identification, rewards program identification, warranty information, product return information, and product exchange information.

10. The apparatus of claim 8, wherein said Electronic Receipt Application Server further comprises:
an Incoming Transaction Processor which receives said Electronic Receipt data and information from one or more of, each of said Retail Front-End Interfaces may be associated with one or more merchant's, and may store said Electronic Receipt data and information in said database.

11. The apparatus of claim 10, wherein said Electronic Receipt Application Server further comprises:
a Merchant E-Receipt Application Server which may access said Electronic Receipt data and information stored on said Database, process said Electronic Receipt data and information, and store said processed Electronic Receipt data and information on said Database; and
a Consumer E-Receipt Application Server which may access said Electronic Receipt data and information stored on said Database, process said Electronic Receipt data and information, and store said processed Electronic Receipt data and information on said Database.

12. The apparatus of claim 11, wherein said User Front-End Interface further comprises:
one or more of a Consumer Web Application, Consumer Mobile Application, and Consumer Desktop Application through which users may input and retrieve said Electronic Receipt data and information, and said processed Electronic Receipt data and information from said Consumer E-Receipt Application Server.

13. The apparatus of claim 11, wherein said Retail Front-End Interface further comprises:
one or more of a Merchant Web Site, Merchant Point of Sale Terminal, Merchant Web Application, Merchant Mobile Application, and Merchant Desktop Application Consumer Web Application, through which Merchants may input and retrieve data and information associated with products and services offered by said Merchant, and said Electronic Receipt data and information and said processed Electronic Receipt data and information from said Merchant E-Receipt Application Server.

14. A system for managing electronic receipts and determining a fair market value of products and services comprising:
an Electronic Receipt Management Subsystem for receiving, storing and managing Electronic Receipts associated with transactions for purchases of one or more of goods and services; and
a Fair Market Value Estimation Subsystem in operable communication with said Electronic Receipt Management Subsystem, wherein said Fair Market Value Subsystem calculates a fair market value of a product or service from a free-form description of said product or service.

15. The system of claim 14, wherein:
said Fair Market Value Estimation Subsystem further comprises:
a FMV Front-End Data Input Device into which data and information associated with a product or service item may be input into said system;
a FMV Application Server, wherein said FMV Application Server may receive said data and information input into said FMV Front-End Data Input Device, process said information and data, and generate a FMV Price Estimate of said Item; and
a database in which one or more of said data, information, and FMV Price Estimate generated by said FMV Application Server may be stored and retrieved; and
said Fair Market Value Estimation Subsystem further comprises:
a Retail Front-End Interface into which data and information associated with products and services offered by one or more Merchants, and Electronic Receipt data and information associated with said transactions may be input into said system by said one or more Merchants;
a User Front-End Interface from which a User of said system may access said user's Electronic Receipt data and information associated with said User's purchases of one or more product or service Items from one or more Merchants;
an Electronic Receipt Application Server, wherein said Electronic Receipt data and information may be received from said Retail Front-End Interface, processed, and accessed by users through said User Front-End Interface; and
a Database in which said Electronic Receipt data and information associated with said transactions for said purchase of one or more of goods and services may be stored and retrieved.

16. The system of claim 14, further comprising:
an Analytics Subsystem which comprises one or more Analytics Engines which may process said Electronic Receipt data and information to generate one or more analytics related to said Electronic Receipt data and information.

17. The system of claim 16, wherein said analytics related to said Electronic Receipt data and information comprises one or more of:
Personalized Fair Price Estimates; Range Adjusted Fair Prices; Consumer-Driven Fair Price Estimates; Price Histories; Price Trends; Related Item Advisories; Product Satisfaction Indexes; Initial Product Quality Indexes; Advertisement Efficiency; Advertising Payments; Price List Grooming; Price List Monitoring; Market Demand Monitoring; Merchant Loyalty Indexes; Brand Loyalty Indexes; Targeted Surveys; Returning Customer Indexes; and Common Carrier Analytics.

18. The system of claim 14, further comprising:
an Alert and Monitoring Subsystem which comprises one or more Monitoring Agents which monitor and alert one or more of said Users and said Merchants regarding metrics associated with said E-Receipt data and information.

19. The system of claim 18, wherein said metrics associated with said E-Receipt data and information may comprise one or more of:
Changes in Fair Market Value of said products and services; Reminders of Expiration of Exchange/Return Periods; Reminders of Expiration of Warranty Periods; Best Deal Alerts; Competitor Price Monitoring; and Purchased Goods Delivery Monitoring.

20. The system of claim 14, wherein said FMV Application Server further comprises:
a Query Processor wherein said Query Processor may receive an Item Description Query, search for Items having descriptions associated with said Item containing one or more terms appearing in said Item Description Query, retrieve said descriptions associated with said searched Items, and normalize said retrieved descriptions associated with said searched Items;
a Data Comparator, wherein said Data Comparator compares data received from said Query Processor and determines if enough data is present to generate a FMV Price Estimate of said Item;
a FMV Price Analysis Engine which, if enough data is associated with said Item Description Query, said FMV Price Analysis Engine analyzes said retrieved descriptions associated with said searched Item, and generates a FMV Price Estimate for said Item associated with said Item Description Query;
a List of Suggested Items Processor, wherein if there is not enough data is associated with said Item Description Query, said List of Suggested Items Processor analyzes said retrieved descriptions associated with said searched Items, generates a List of Suggested Items, organizes said List of Suggested Items, and provides for the storage of said List of Suggested Items for use in the processing of subsequent Item Description Queries; and
a Textual Analysis Engine which may generate a dictionary of one or more of preferred or correct words and phrases present in said List of Suggested Items for use in the processing of subsequent Item Description Queries.
